(19) United States
(12) Patent Application Publication
(10) Pub. No.: US 2011/0187759 A1
(43) Pub. Date: Aug. 4, 2011

(54) LIQUID CRYSTAL DEVICE, METHOD OF CONTROLLING LIQUID CRYSTAL DEVICE, AND ELECTRONIC APPARATUS

(75) Inventors: Hitoshi SASAKI, Shiojiri-shi (JP); Hidehito IISAKA, Shiojiri-shi (JP); Kasuhisa MIZUSAKO, Chino-shi (JP)

(73) Assignee: SEIKO EPSON CORPORATION, Tokyo (JP)

(21) Appl. No.: 13/013,686

(22) Filed: Jan. 25, 2011

(30) Foreign Application Priority Data
Feb. 2, 2010 (JP) 2010-021363

(51) Int. Cl. G09G 5/10

(52) U.S. Cl. 345/690; 345/89

(57) ABSTRACT

A liquid crystal device includes: a scanning line selecting circuit that selects a plurality of scanning lines in a predetermined order in each of a positive-polarity field and a negative-polarity field; a data line driving circuit that supplies a voltage corresponding to a gray scale of a pixel positioned on a one scanning line to the data line corresponding to the pixel as the data signal; a detection circuit that detects brightness of the pixel positioned on the one scanning line; and a control circuit that controls period lengths of the positive-polarity and negative-polarity fields based on a detection result of the detection circuit such that a difference between brightness of the pixel when the pixel maintains a voltage of the positive polarity and brightness of the pixel when the pixel maintains a voltage of the negative polarity is gradually changed in a predetermined range.

The entire disclosure of Japanese Patent Application No. 2010-021363, filed Feb. 2, 2010 is expressly incorporated by reference herein.

### BACKGROUND

1. Technical Field

The present invention relates to a technology for suppressing the generation of flicker in an electro-optical device.

2. Related Art

A liquid crystal element used in liquid crystal display devices is configured so as to pinch a liquid crystal by using two electrodes. However, when a DC component is applied to the liquid crystal element, the liquid crystal is degraded. Accordingly, in liquid crystal display devices, generally, the liquid crystal element is driven by an alternating current. However, there are cases where a DC component is applied to the liquid crystal even when only AC driving is performed. Thus, a technology for adjusting a voltage applied to one electrode of the liquid crystal element such that flicker is minimized, that is, a difference between transmittance (brightness) due to application of a voltage having a positive polarity and transmittance due to application of a voltage having a negative polarity is minimized is known (for example, see JP-A-2008-197363).

However, even when the voltage applied to the electrode is adjusted so as to minimize the flicker, there are cases where a DC component is applied to the liquid crystal element due to aging over time or the like. According to the invention disclosed in JP-A-2008-197363, the voltage can be adjusted by a user, and accordingly, the voltage of the electrode can be readjusted after factory shipment. However, an adjustment operation that is different from an ordinary operation needs to be performed by the user. In addition, unless readjustment is performed by the user, the voltage of the electrode is not readjusted. Therefore, a state in which flicker is generated may continue.

### SUMMARY

An advantage of some aspects of the invention is that it provides a technology capable of suppressing generation of flicker by suppressing application of a DC component to the liquid crystal without an adjustment operation of a user.

According to an aspect of the invention, there is provided a liquid crystal device including a plurality of pixels disposed in correspondence with intersections of a plurality of scanning lines and a plurality of data lines and each having a gray scale according to a voltage of a data signal supplied to the data lines when the scanning line is selected. As a voltage corresponding to a gray scale of the pixel positioned on the scanning line, a positive-polarity field in which a voltage having a positive polarity that has an electric potential higher than a predetermined electric potential as a reference is supplied to the data line corresponding to the pixel as the data signal and a negative-polarity field in which a voltage having a negative polarity that has an electric potential lower than the predetermined electric potential as a reference is supplied to the data line corresponding to the pixel as the data signal are included. The liquid crystal device includes: a scanning line selecting circuit that selects the plurality of scanning lines in a predetermined order in each of the positive-polarity field and the negative-polarity field; a data line driving circuit that, in a case where one scanning line is selected in the positive-polarity field, supplies a voltage corresponding to a gray scale of the pixel positioned on the one scanning line to the data line corresponding to the pixel as the data signal and, in a case where the one scanning line is selected in the negative-polarity field, supplies a voltage corresponding to a gray scale of the pixel positioned on the one scanning line to the data line corresponding to the pixel as the data signal; a detection circuit that detects brightness of the pixel positioned on the one scanning line; and a control circuit that controls period lengths of the positive-polarity and negative-polarity fields based on a detection result of the detection circuit such that a difference between brightness of the pixel when the pixel maintains a voltage of the positive polarity and brightness of the pixel when the pixel maintains a voltage of the negative polarity is gradually changed in a predetermined range.

According to the above-described liquid crystal device, the positive-polarity field and the negative-polarity field are configured, and when a voltage having the positive polarity is written into a pixel in the positive polarity field, a voltage having the negative polarity is written into the pixel in the negative-polarity field. In addition, based on the brightness level at a time when the pixel maintains a voltage having the positive polarity and the brightness level at a time when the pixel maintains a voltage having the negative polarity, the period lengths of the positive-polarity field and the negative-polarity field are controlled such that a difference between the brightness level at the time of maintaining the voltage having the positive polarity and the brightness level at the time of maintaining the voltage having the negative polarity is gradually changed in a predetermined range. Accordingly, the generation of flicker can be suppressed without performing an operation for adjusting the voltage of the opposing electrode.

In the above-described liquid crystal device, it may be configured that the detection circuit includes an optical sensor that detects brightness of a detection pixel that is determined in advance out of the plurality of pixels, detects the brightness of the pixel at a time when the detection pixel maintains the voltage having the positive polarity and the brightness of the pixel at a time when the detection pixel maintains the voltage having the negative polarity by using the optical sensor, and the data line driving circuit supplies a voltage corresponding to a halftone gray scale that is determined in advance to the detection pixel.

In the above-described liquid crystal device, it may be configured that the control circuit includes a first set value that is used for setting the period lengths of the positive-polarity and negative-polarity fields and a second set value that is used for setting the period lengths of the positive-polarity and negative-polarity fields, the first set value is a value used for setting the period lengths of the positive-polarity and negative-polarity fields such that the brightness of the pixel at a time of maintaining the voltage having the negative polarity is higher than the brightness of the pixel at a time of maintaining the voltage having the positive polarity, the second set value is a value used for setting the period lengths of the positive-polarity and negative-polarity fields such that the brightness of the pixel at the time of maintaining the voltage having the positive polarity is higher than the brightness of the pixel at the time of maintaining the voltage having the negative polarity, and the control circuit selects the first set value or the second set value based on the detection result of the detection circuit and controls the period lengths of the positive-polarity and the negative-polarity fields according to the selected set value.

In the above-described liquid crystal device, the control circuit may be configured so as to select the first set value in a case where the pixel at the time of maintaining the voltage having the positive polarity is brighter than the pixel at the time of maintaining the voltage having the negative polarity and selects the second set value in a case where the pixel at the time of maintaining the voltage having the negative polarity is brighter than the pixel at the time of maintaining the voltage having the positive polarity.

In the above-described liquid crystal device, one of the first set value and the second set value may be a value that is used for setting the period lengths of the positive-polarity and negative-polarity fields to be the same.

In addition, in the above-described liquid crystal device, at least one of the first set value and the second set value may be changed to the value that is used for setting the period lengths of the positive-polarity and negative-polarity fields to be the same based on the detection result of the detection circuit.

In addition, in the above-described liquid crystal device, the first set value and the second set value may be configured to be changed based on the detection result of the detection circuit.

According to another aspect of the invention, there is provided a liquid crystal device including a plurality of pixels disposed in correspondence with intersections of a plurality of scanning lines and a plurality of data lines and each having a gray scale according to a voltage of a data signal supplied to the data lines when the scanning line is selected. As a voltage corresponding to a gray scale of the pixel positioned on the scanning line, a positive-polarity field in which a voltage having a positive polarity that has an electric potential higher than a predetermined electric potential as a reference is supplied to the data line corresponding to the pixel as the data signal and/or a negative-polarity field in which a voltage having a negative polarity that has an electric potential lower than the predetermined electric potential as a reference is supplied to the data line corresponding to the pixel as the data signal are included. The liquid crystal device includes: a scanning line selecting circuit that selects the plurality of scanning lines in a predetermined order in each of the positive-polarity field and the negative-polarity field; a data line driving circuit that, in a case where one scanning line is selected in the positive-polarity field, supplies a voltage corresponding to a gray scale of the pixel positioned on the one scanning line to the data line corresponding to the pixel as the data signal and, in a case where the one scanning line is selected in the negative-polarity field, supplies a voltage corresponding to a gray scale of the pixel positioned on the one scanning line to the data line corresponding to the pixel as the data signal; a detection circuit that detects flicker of the pixel positioned on the one scanning line in the positive-polarity and negative-polarity fields; and a control circuit that controls period lengths of the positive-polarity and negative-polarity fields based on a detection result of the detection circuit such that the flicker is gradually changed in a predetermined range. The control circuit includes a first set value that is used for setting the period lengths of the positive-polarity and negative-polarity fields and a second set value that is used for setting the period lengths of the positive-polarity and negative-polarity fields, the first set value is a value used for setting the period lengths of the positive-polarity and negative-polarity fields such that the brightness of the pixel at a time of maintaining the voltage having the negative polarity is higher than the brightness of the pixel at a time of maintaining the voltage having the positive polarity, the second set value is a value used for setting the period lengths of the positive-polarity and negative-polarity fields such that the brightness of the pixel at the time of maintaining the voltage having the positive polarity is higher than the brightness of the pixel at the time of maintaining the voltage having the negative polarity, and the control circuit selects the first set value or the second set value based on the detection result of the detection circuit and controls the period lengths of the positive-polarity and the negative-polarity fields.

In addition, the aspect of the invention may be conceived not only as a liquid crystal device but also as a method of controlling a liquid crystal device or an electronic apparatus including the liquid crystal device.

### BRIEF DESCRIPTION OF THE DRAWINGS

The invention will be described with reference to the accompanying drawings, wherein like numbers reference like elements.

FIG. 1 is a block diagram showing the configuration of an electro-optical device according to a first embodiment of the invention.

FIG. 2 is a diagram showing the configuration of a display panel of the electro-optical device.

FIG. 3 is a diagram showing the configuration of pixels of the display panel.

FIG. 4 is a diagram showing the operation of a scanning line driving circuit of the display panel.

FIG. 5 is a diagram showing an example of the voltage waveform of a data signal in the display panel.

FIG. 6 is a diagram showing an example of the voltage waveform of a data signal in the display panel.

FIG. 7 is a diagram showing the arrangement position of an optical sensor according to the embodiment.

FIG. 8 is a block diagram showing the configuration of a data analyzing unit of the electro-optical device.

FIG. 9 is a diagram showing the transition of writing data into a pixel in a display region.

FIG. 10 is a diagram showing the operation of a scanning line driving circuit of the display panel.

FIG. 11 is a diagram showing the transition of writing data into a pixel in the display region.

FIG. 12 is a diagram showing the operation of a scanning line driving circuit of the display panel.

FIG. 13 is a diagram showing the transition of writing data into a pixel in the display region.

FIG. 14 is a flowchart showing the flow of the process of a control circuit.

FIG. 15 is a flowchart showing the flow of the process of a control circuit according to a second embodiment of the invention.

FIG. 16 is a flowchart showing the flow of the process of the control circuit according to the second embodiment.

FIG. 17 is a flowchart showing the flow of the process of a control circuit according to a third embodiment of the invention.

FIG. 18 is a flowchart showing the flow of the process of the control circuit according to the third embodiment.

FIG. 19 is a flowchart showing the flow of the process of a control circuit according to a fourth embodiment of the invention.

FIG. 20 is a flowchart showing the flow of the process of the control circuit according to the fourth embodiment.

FIG. 21 is a diagram showing the configuration of a projector using an electro-optical device according to an embodiment of the invention.

FIG. 22 is a flowchart showing the flow of the process of a control circuit according to a modified example.

FIG. 23 is a flowchart showing the flow of the process of a control circuit according to another modified example.

### DESCRIPTION OF EXEMPLARY EMBODIMENTS

### First Embodiment

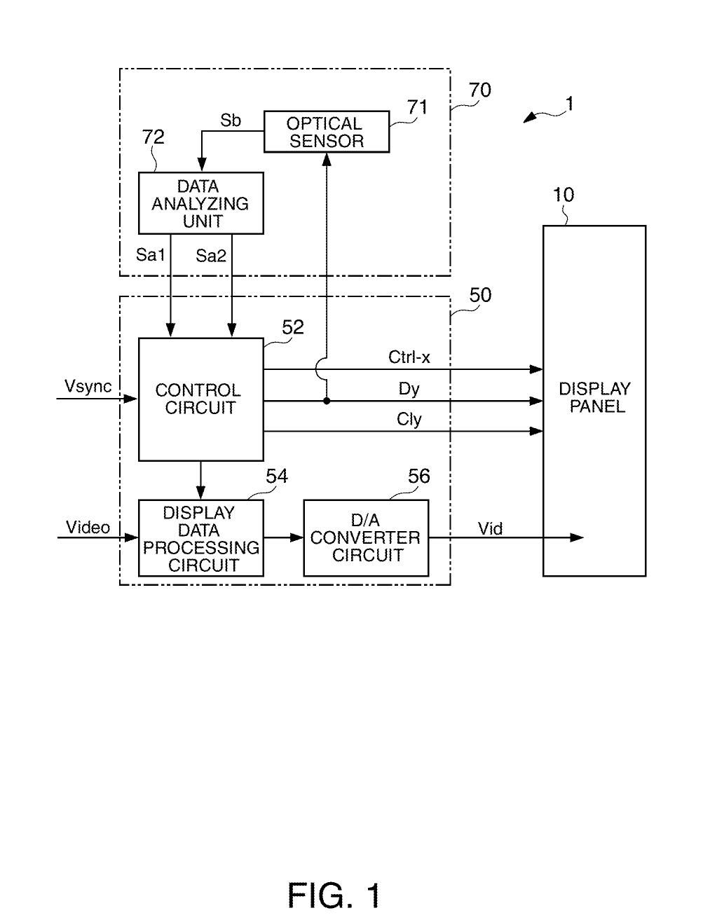

FIG. 1 is a block diagram showing the configuration of an electro-optical device 1 according to the first embodiment of the invention.

As shown in FIG. 1, the electro-optical device 1 is basically divided into a display panel 10, a processing circuit 50, and a detection circuit 70. Among these, the processing circuit 50 that is a circuit module controlling the operation of the display panel 10 and the like includes a control circuit 52, a display data processing circuit 54, and a D/A converter circuit 56. The processing circuit 50 is connected to the display panel 10, for example, through an FPC (flexible printed circuit) substrate. The detection circuit 70 includes an optical sensor 71 and a data analyzing unit 72. The electro-optical device 1 is an example of a liquid crystal device that displays an image by using a liquid crystal.

The control circuit 52 generates various control signals that are used for controlling the display panel 10 in synchronization with a synchronization signal Vsync that is supplied from an external high-level device (not shown). These control signals will be described later as is appropriate. In addition, the control circuit 52 controls the display data processing circuit 54 together with generating various control signals.

The display data processing circuit 54 temporarily stores display data Video, which is supplied from the external high-level device, in an internal memory (not shown) under the control of the control circuit 52 and then reads out the display data in synchronization with driving of the display panel 10. The display data Video is data that designates gray scales of pixels of the display panel 10. Although the waveform of the display data is not shown in the figure, the display data corresponding to one frame (all the pixels of the display panel 10) is supplied at the cycle of 16.7 milliseconds (a frequency of 60 Hz). The D/A converter circuit 56 converts the display data read out under the control of the control circuit 52 into an analog data signal Vid.

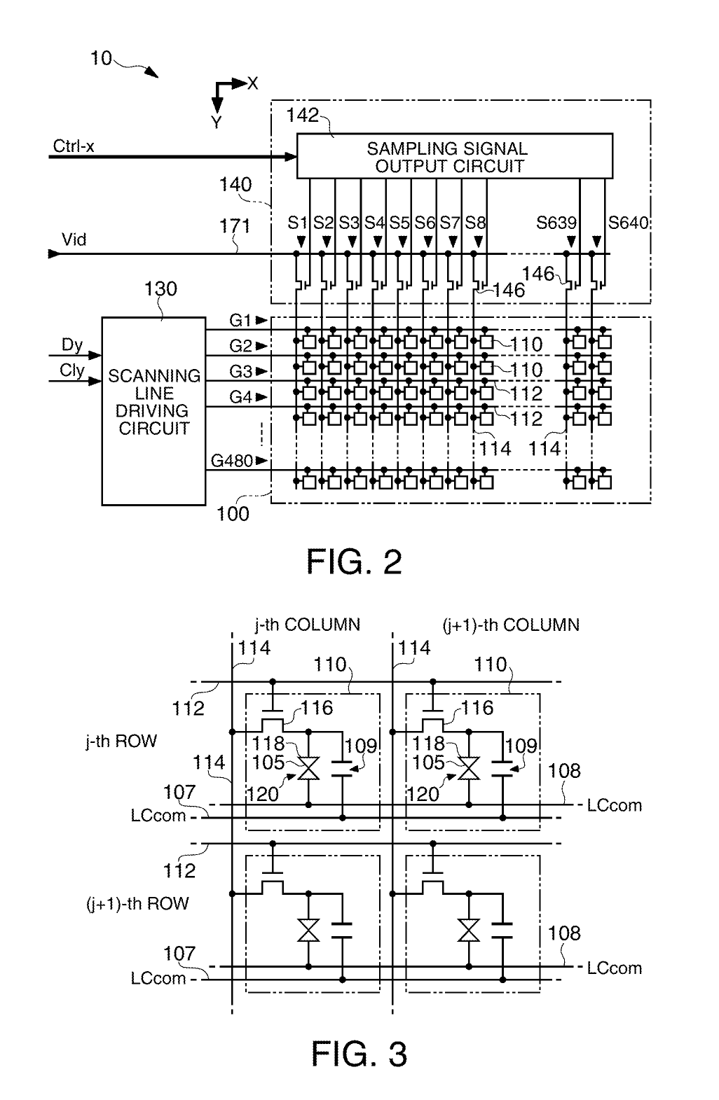

Next, the display panel 10 will be described. FIG. 2 is a diagram showing the configuration of the display panel 10. As shown in the figure, the display panel 10 is configured as a peripheral circuit built-in type in which a scanning line driving circuit 130 and a data line driving circuit 140 are built-in at the periphery of a display region 100. In the display region 100, 480 scanning lines 112 are disposed so as to extend in the row direction (X direction), and 640 data lines 114 are disposed so as to extend in the column direction (Y direction) and maintained to be electrically insulated from the scanning lines 112. In addition, pixels 110 are arranged in correspondence with intersections of the 460 scanning lines 112 and the 640 data lines 114. Thus, according to this embodiment, the pixels 110 are arranged in the shape of a matrix of vertical 480 rows×horizontal 640 columns in the display region 100. However, the invention is not limited to such an arrangement.

The configuration of the pixel 110 will be described with reference to FIG. 3. FIG. 3 shows the configuration of a total of four pixels of 2×2 corresponding to the i-th row and the (i+1)-th row adjacent to the i-th row to the lower side and the j-th column and the (j+1)-th column adjacent to the j-th column to the right side. Here, “i” and “(i+1)” are symbols generally representing a row in which the pixel 110 is arranged, and are integers equal to or greater than 1 and equal to or less than 480. In addition, “j” and “(j+1)” are symbols generally representing columns in which the pixel 110 is arranged, and are integers equal to or greater than 1 and equal to or less than 640.

As shown in FIG. 3, each pixel 110 includes an n-channel TFT 116 and a liquid crystal capacitor 120. Here, since each pixel 110 has the same configuration, a pixel positioned at the i-th row and the j-th column will be representatively described. In the pixel 110 positioned at the i-th row and the j-th column, the gate electrode of the TFT 116 is connected to the scanning line 112 positioned in the i-th row, the source electrode thereof is connected to the data line 114 positioned in the j-th column, and the drain electrode is connected to a pixel electrode 118 that is one end of the liquid crystal capacitor 120. In addition, the other end of the liquid crystal capacitor 120 is connected to an opposing electrode 108. This opposing electrode 108 is common to all the pixels 110 and is applied with a temporally constant voltage LCcom.

This display panel 10, although not particularly shown in the figure, has a configuration in which one pair of substrates including a component substrate and an opposing substrate are bonded so as to be spaced apart from each other by a predetermined gap, and a liquid crystal is sealed inside the gap. Among these, the scanning lines 112, the data lines 114, the TFTs 116, the pixel electrodes 118 are formed together with the scanning line driving circuit 130 and the data line driving circuit 140 on the component substrate, the opposing electrode 108 is formed on the opposing substrate, and the component substrate and the opposing substrate are bonded so as to be spaced apart by a predetermined gap, so that electrode forming faces thereof face each other. Accordingly, in the embodiment, the liquid crystal capacitor 120 is configured by having the liquid crystal 105 pinched by the pixel electrode 118 and the opposing electrode 108.

In this embodiment, a normally white mode is set in which the transmittance of light passing through the liquid crystal capacitor is maximized so as to implement a white display as the value of the effective voltage maintained in the liquid crystal capacitor 120 is close to zero, and the amount of transmitted light decreases as the value of the effective voltage increases so as to finally implement a black display in which the transmittance is the minimum.

In such a configuration, when a selection voltage is applied to the scanning line 112 so as to turn on the TFT 116 (to be in a conduction state), and a data signal of a voltage corresponding to the gray scale (brightness) is supplied to the pixel electrode 118 through the data line 114 and the TFT 116 that is in the ON state, the value of the effective voltage corresponding to the gray scale can be maintained in the liquid crystal capacitor 120 corresponding to the intersection of the scanning line 112 to which the selection voltage is applied and the data line 114 to which the data signal is supplied.

Accordingly, light transmitting through the liquid crystal capacitor 120 can be controlled to be different for each pixel, and thereby an image is formed in the display region 100. The formed image is directly viewed by a user or is projected in an enlarged scale by a projector to be described later so as to be visually recognized. In either case, the brightness of the pixels of the display panel 10 is detected by the optical sensor 71.

When the voltage of the scanning line 112 is a non-selection voltage, the TFT 116 is in the OFF (non-conduction) state. However, since the off-resistance at this time is not infinite, which is not ideal, electric charge accumulated in the liquid crystal capacitor 120 leaks quite significantly. In order to decrease the influence of the off-leakage, a storage capacitor 109 is formed in each pixel. One end of the storage capacitor 109 is connected to the pixel electrode 118 (the drain of the TFT 116), and the other end thereof is connected in common to the capacitor line 107 across all the pixels. This capacitor line 107 is maintained at a temporally constant electric potential, for example, the same voltage LCcom as that of the opposing electrode 108.

The scanning line driving circuit 130 supplies scanning signals G1, G2, G3, . . . , G480 to the scanning lines 112 positioned in the first, second, third, . . . , 480th rows. Here, the scanning line driving circuit 130 sets the scanning signal input to a selected scanning line to an H level corresponding to the voltage Vdd and sets the scanning signals input to the other scanning lines to an L Level corresponding to a non-selection voltage (ground electric potential Gnd).

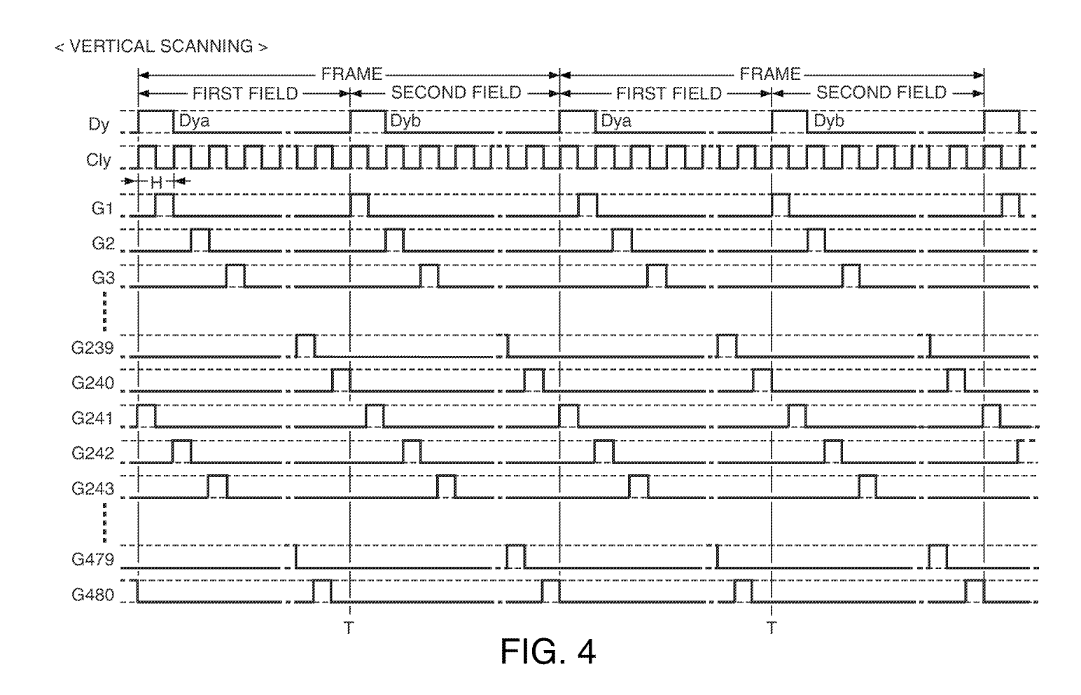

FIG. 4 is a timing chart showing the scanning signals G1 to G480, which are output by the scanning line driving circuit 130, in relation to start pulses Dya and Dyb and a clock signal Cly.

As shown in the figure, each scanning line 112 is selected twice during one frame. Here, the frame represents a period that is necessary for displaying one image on the display panel 10. Since the display data Video is supplied at the cycle of 16.7 milliseconds as described above, one frame coincides with the cycle of 16.7 milliseconds.

The control circuit 52 outputs the clock signals Cly of 480 cycles having a duty ratio of 50%, of which the number is the same as the number of the scanning lines, during one frame period. In FIG. 4, a period corresponding to one cycle of the clock signal Cly is denoted by H.

In addition, the control circuit 52 outputs the start pulses Dya and Dyb each having a pulse width corresponding to one cycle of the clock signal Cly as follows when the clock signal Cly starts to be in the H level. The control circuit 52 outputs the start pulse Dya during the initial period (that is, the initial period of the first field) of one frame period, and outputs the start pulse Dyb at timing T when 240 cycles of clock signals Cly are output after the output of the start pulse Dya (in other words, when a half period of one frame elapses).

However, as will be described later, there is a case where the control circuit 52 outputs the start pulse Dyb to the forward side or the backward side temporally only the amount set in one unit of the cycles of the clock signal Cly with respect to the timing T.

Of one frame period, a period until the start pulse Dyb is output after the output of the start pulse Dya is set as a first field, and a period until the next start pulse Dya is output after the output of the start pulse Dyb is set as a second field.

Here, the start pulses Dya and Dyb are alternately output, and the start pulse Dya thereof is output every start timing of one frame, that is, every 16.7 milliseconds. Accordingly, when the start pulse Dya is specified, consequently the start pulse Dyb can be specified. Thus, in FIGS. 1, 2, and the like, there are cases where neither of the start pulses are particularly differentiated from each other and are denoted by start pulses Dy.

The scanning line driving circuit 130 outputs the scanning signals G1 to G480 shown in FIG. 4 in accordance with the start pulses Dya and Dyb and the clock signal Cly described above. In other words, when the start pulse Dya is supplied, the scanning line driving circuit 130 sequentially sets the scanning signals G1 to G480 to the H level during a period in which the clock signal Cly is in the L level. In addition, when the start pulse Dyb is supplied, the scanning line driving circuit 130 sequentially sets the scanning signals G1 to G480 to the H level during a period in which the clock signal Cly is in the H level.

Accordingly, in accordance with supply of the start pulse Dya, the scanning lines are selected in the order of the first, second, third, fourth, . . . , 480th rows toward the lower side of the screen from the first field to the second field of a frame during a half cycle of the clock signal Cly. In addition, in accordance with supply of the start pulse Dyb, the scanning lines are selected in the order of the first, second, third, fourth, . . . , 480th rows toward the lower side of the screen from the second field of a frame to the first field of the next frame during a selection interval that is triggered by the supply of the start pulse Dya.

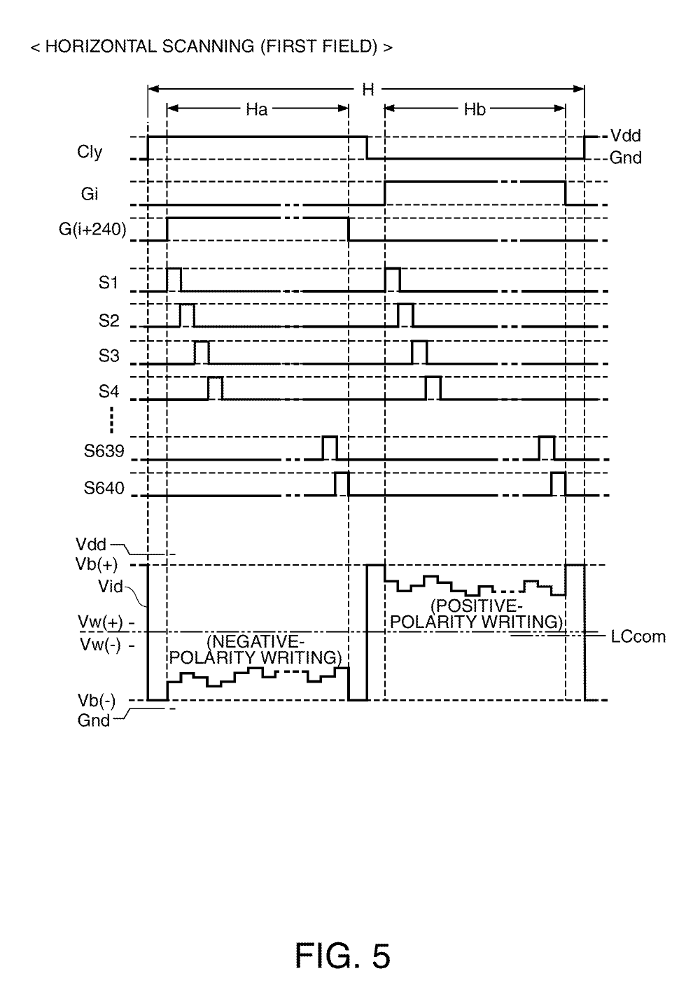

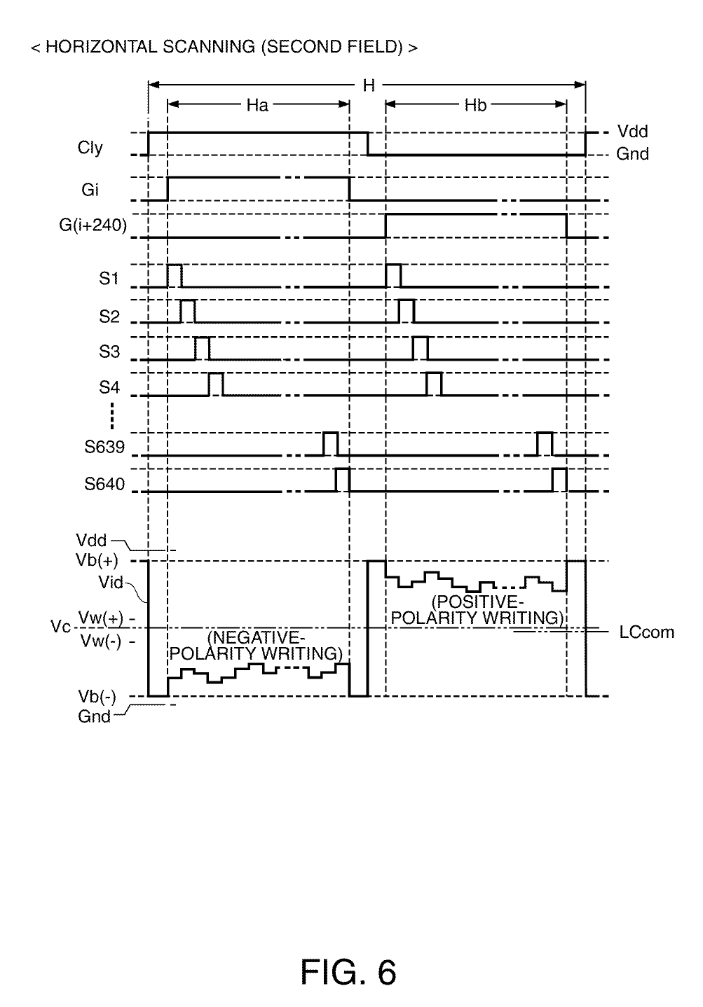

The data line driving circuit 140 is configured by a sampling signal output circuit 142 and n-channel TFTs 146 that are disposed in correspondence with the data lines 114. The sampling signal output circuit 142, in accordance with a control signal Ctrl-x of the control circuit 52, as shown in FIGS. 5 and 6, outputs sampling signals S1, S2, S3, . . . , S640 that are sequentially in the H level in an exclusive manner during a period during which a scanning line 112 is selected and a scanning signal supplied to the scanning line is in the H level in correspondence with the data lines 114. In addition, although the control signal Ctrl-x is actually a start pulse or a clock signal, it is not directly relating to an embodiment of the invention. Thus, the description thereof is omitted. In addition, actually, the period during which the scanning signal is in the H level, as shown in FIGS. 5 and 6, is slightly shorter than a half cycle of the clock signal Cly.

The D/A converter circuit 56 shown in FIG. 1 converts the display data Video corresponding to one row of pixels positioned in the scanning line 112 that is selected by the scanning line driving circuit 130 into a data signal Vid having the following polarity in accordance with the output of the sampling signals S1 to S640 output from the sampling signal output circuit 142.

The D/A converter circuit 56 converts the data signal Vid of a pixel positioned in a row selected when the clock signal Cly is in the L level into a positive polarity and converts the data signal Vid of a pixel positioned in a row selected when the clock signal Cly is in the H level into a negative polarity.

The positive polarity represents a voltage higher than a reference voltage Vc (see FIG. 5) that is set higher than the voltage LCcom applied to the opposing electrode 108, and the negative polarity represents a voltage lower than the reference voltage Vc. In this embodiment, regarding the polarity of the data signal, the voltage Vc is used as a reference. However, regarding a voltage, unless otherwise mentioned, the ground electric potential Gnd corresponding to the L level as a logic level is used as a reference of zero voltage.

Next, the optical sensor 71 and the data analyzing unit 72 will be described. The optical sensor 71 is a sensor that detects the brightness of a pixel of the display panel 10. The optical sensor 71 has a photodiode. When light is incident to the photodiode, the optical sensor 71 converts a change in the current flowing through the photodiode into a change in the voltage by using a current-voltage converting circuit and supplies an analog signal Sb representing the brightness of the pixel to the control circuit 52. In this embodiment, the signal Sb output from the optical sensor 71 represents the brightness of a pixel according to a voltage value, and the voltage of the signal Sb changes in accordance with the detected brightness.

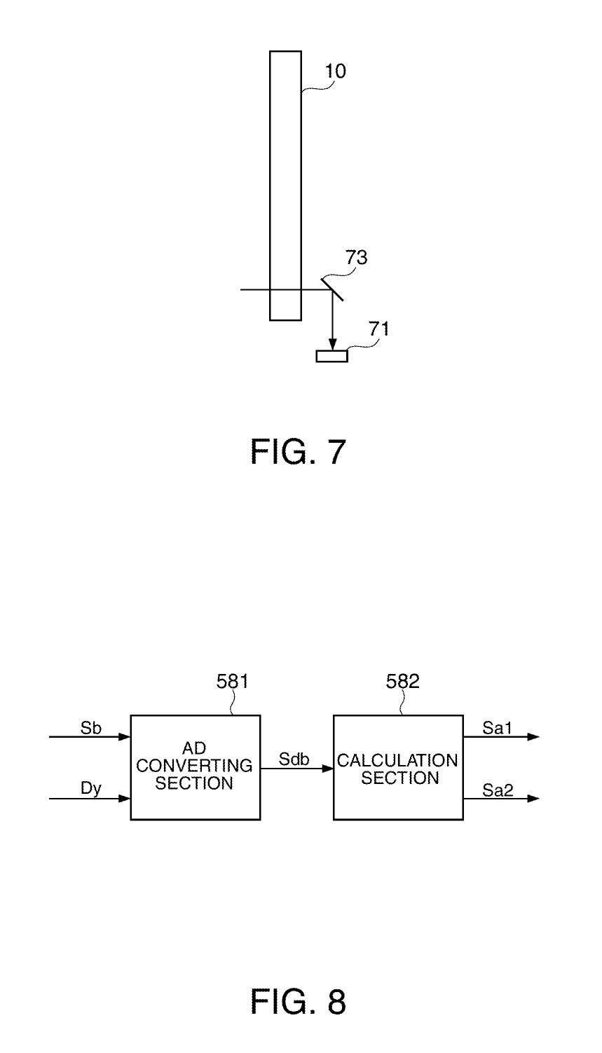

As shown in FIG. 7, the optical sensor 71 is disposed near the display panel 10. The light transmitted through the display panel 10, as denoted by an arrow shown in FIG. 7, is guided to the optical sensor 71 by a mirror 73. In this embodiment, light of a pixel positioned in the 480th row is guided to the optical sensor 71 by the mirror 73, and the brightness of this pixel (detection pixel) is detected.

FIG. 8 is a block diagram showing the configuration of the data analyzing unit 72. The data analyzing unit 72 acquires the signal Sb that is supplied from the optical sensor 71 and outputs information on the brightness of the pixel based on the acquired signal Sb. The data analyzing unit 72 includes an AD converting section 581 and a calculation section 582.

The AD converting section 581 acquires the signal Sb from the optical sensor 71. In addition, the AD converting section 581 acquires the start pulse Dy and the clock signal Cly from the control circuit 52. The AD converting section 581 counts the number of clock signals Cly from the start of the start pulse Dy and converts the signal Sb into a digital signal Sdb at timing before the start of the scanning signal G480. The AD converting section 581 outputs the digital signal Sdb acquired through the conversion to the calculation section 582.

The pixel positioned in the 480-th row maintains a voltage having the positive polarity therein until the scanning signal G480 is output after the output of the start pulse Dya. Accordingly, the digital signal Sdb acquired by being triggered by the start pulse Dya represents the brightness of the pixel positioned in the 480-th row when the pixel maintains a voltage having the positive polarity.

In addition, the pixel positioned in the 480-th row maintains a voltage having the negative polarity therein until the scanning signal G480 is output after the output of the start pulse Dyb. Accordingly, the digital signal Sdb acquired by being triggered by the start pulse Dyb represents the brightness of the pixel positioned in the 480-th row when the pixel maintains a voltage having the negative polarity.

The calculation section 582 performs a fast Fourier transform process for the digital signal Sdb that is supplied from the AD converting section 581. When there is a difference in the brightness levels of the pixel due to application of a DC component to the liquid crystal at the time of maintaining a voltage having the positive polarity and at the time of maintaining a voltage having the negative polarity, the value of the digital signal Sdb changes in correspondence with the difference. Accordingly, when the fast Fourier transform is performed for a waveform that represents the change in the digital signal Sdb, the amplitude of the signal Sb can be acquired. In addition, the difference in the brightness levels at the time when the pixel positioned in the 480-th row maintains a voltage having the positive polarity and at the time when the pixel maintains a voltage having the negative polarity can be acquired based on the amplitude. The calculation section 582 outputs a signal Sa1, which is acquired through the fast Fourier transform, representing the difference in the brightness levels to the control circuit 52.

In a case where the brightness at the time when the pixel maintains a voltage having the positive polarity is higher than the brightness at the time when the pixel maintains a voltage having the negative polarity, the value of a digital signal Sdb that is acquired by being triggered by the start pulse Dyb is greater than the value of a digital signal Sdb acquired by being triggered by the start pulse Dya. In addition, in a case where the brightness at the time when the pixel maintains a voltage having the negative polarity is higher than that at the time when the pixel maintains a voltage having the positive polarity, the value of a digital signal Sdb that is acquired by being triggered by the start pulse Dya is greater than the value of a digital signal Sdb that is acquired by being triggered by the start pulse Dyb.

In other words, when a change in the value of a digital signal is represented in a waveform, the phase of the waveform differs in a case where the brightness increases at a time when the pixel maintains a voltage having the positive polarity and in a case where the brightness increases at a time when the pixel maintains a voltage having the negative polarity. Accordingly, by acquiring the phase of the waveform of a digital signal according to the fast Fourier transform process, it can be known whether a case where the pixel maintains a voltage having the positive polarity or a case where the pixel maintains a voltage having the negative polarity is in a brighter state.

In addition, the calculation section 582, instead of acquiring the phase of the waveform of a digital signal through the fast Fourier transform process, may determine that a pixel of the case where a voltage having the positive polarity is maintained is brighter in a case where the value of a digital signal Sdb that is acquired by being triggered by the start pulse Dyb is greater than the value of a digital signal Sdb that is acquired by being triggered by the start pulse Dya and determine that a pixel of the case where a voltage having the negative polarity is maintained is brighter in a case where the value of a digital signal Sdb that is acquired by being triggered by the start pulse Dya is greater than the value of a digital signal Sdb that is acquired by being triggered by the start pulse Dyb.

The calculation section 582 detects whether the case where the pixel maintains a voltage having the positive polarity and the case where the pixel maintains a voltage having the negative polarity is in a brighter state by using any of the above-described methods, and outputs to the control circuit 52 a signal Sa2 that represents the positive polarity in a case where the pixel maintaining a voltage having the positive polarity is in the brighter state or represents the negative polarity in a case where the pixel maintaining a voltage having the negative polarity is in the brighter state.

The control circuit 52 acquires the signals Sa1 and Sa2 output from the calculation section 582 and designates output timing of the start pulse Dyb using the acquired signals. More specifically, the control circuit 52 stores a first set value and a second set value that are set in advance as the set values used for designating the output timing of the start pulse Dyb. In this embodiment, the second set value is a positive integer value, and the first set value is a negative integer value.

In addition, the control circuit 52 includes a register that stores the first set value and the second set value therein. The control circuit 52 changes the output timing of the start pulse Dyb in correspondence with the value stored in the register.

Hereinafter, the output timing of the start pulse Dyb will be described.

First, after storing the display data Video supplied from the external high-level device in the internal memory of the display data processing circuit 54, the control circuit 52 reads out the display data of a row at double speed of the storing speed when a scanning line positioned in the row of the display panel 10 is selected, and controls the sampling signal output circuit 142 through the control signal Ctrl-x such that the sampling signals S1 to S640 sequentially are in the H level in the mentioned order in accordance with read-out of the display data. In addition, the read-out display data is converted into an analog data signal Vid by the D/A converter circuit 56.

Here, when the value stored in the register is “0”, the control circuit 52 supplies the start pulse Dyb at timing T. When supplying the start pulse Dyb at timing T, the control circuit 52 selects the scanning lines 112 in the order of the 241st, first, 242nd, second, 243rd, third, . . . , 480th, and 240th rows in the first field. Accordingly, the control circuit 52 controls the scanning line driving circuit 130 such that the scanning line 112 positioned in the 241st row is selected first. In addition, the control circuit 52 controls the display data processing circuit 54 to read out the display data Video corresponding to the 241st row stored in the memory at double speed controls, the D/A converter circuit 56 to convert the data into a data signal Vid having the negative polarity, and controls the sampling signal output circuit 142 such that the sampling signals S1 to S640 are exclusively in the H level in the mentioned order in accordance with the read-out operation. When the sampling signals S1 to S640 are sequentially in the H level, the TFTs 146 are sequentially turned on, and the data signals Vid supplied to the image signal lines 171 are sequentially sampled in the data lines 114 positioned in the first to 640th columns.

On the other hand, when the scanning line 112 positioned in the 241st row is selected and the scanning signal G241 is in the H level, all the TFTs 116 of the pixels 110 positioned in the 241st row are turned on. Accordingly, the voltages of the data signals Vid, which have the negative polarity, sampled in the data line 114 are directly applied to the pixel electrodes 118. Therefore, in the liquid crystal capacitors 120 of the pixels positioned in the first, second, third, fourth, . . . , 639th, and 640th columns and the 241st row, voltages, which have the negative polarity, corresponding to the gray scale designated by the display data Video are written and maintained.

Next, the control circuit 52 controls the scanning line driving circuit 130 so as to select the scanning line 112 positioned in the first row. In addition, the control circuit 52 controls the display data processing circuit 54 to read out the display data Video corresponding to the first row stored in the memory at double speed and the D/A converter circuit 56 to convert the data into a data signal Vid having the positive polarity, and controls the sampling signal output circuit 142 such that the sampling signals S1 to S640 are exclusively in the H level in the mentioned order in accordance with the read-out operation.

When the scanning line 112 positioned in the first row is selected, and the scanning signal G1 is in the H level, all the TFTs 116 of the pixels 110 positioned in the first row are turned on. Accordingly, the voltages of the data signals Vid sampled in the data lines 114 are applied to the pixel electrodes 118. Therefore, in the liquid crystal capacitors 120 of the pixels positioned in the first to 640th columns and the first row, voltages, which have the positive polarity, corresponding to the gray scale designated by the display data Video is written and maintained.

Hereinafter, in the first field, the same voltage writing operation is performed in the order of the 242nd, second, 243rd, third, . . . , 480th, and 240th rows. Accordingly, voltages having the positive polarity that correspond to the gray scales are written into the pixel positioned in the first row to the 240th row, voltages having the negative polarity that correspond to the gray scales are written into the pixels positioned in the 241st row to the 480th row, and the voltages are maintained.

In addition, when the start pulse Dyb is supplied at timing T, in the second field, the scanning lines 112 are selected in the order of the first, 241st, second, 242nd, third, 243rd, fourth, 244th, . . . , 240th, and 480th rows, and the writing polarity in the same rows are inverted. Accordingly, voltages having the negative polarity that correspond to the gray scales are written into the pixels of the first row to the 240th row, voltages having the positive polarity that correspond to the gray scales are written into the pixels of the 241st row to the 480th row, and the voltages are maintained.

FIG. 5 shows an example of the voltage waveform of the data signal Vid at a time when the scanning line positioned in the (i+240)-th row and the scanning line positioned in the i-th row are selected in the first field.

In this figure, voltages Vb (+) and Vb (−) are voltages having the positive polarity and the negative polarity that correspond to a black color of the lowest gray scale and are symmetrical to each other with respect to a reference voltage Vc as the center thereof. In a case where the black color of the lowest gray scale is designated when the decimal value of the gray scale value designated by the display data Video is “0”, and a brighter gray scale is designated as the decimal value increases therefrom, since this embodiment employees a normally white mode, in a case where the voltage is converted into the positive polarity, the voltage of the data signal Vid becomes a voltage that swings from the voltage Vb (+) to the lower electric potential side as the gray scale value increases. On the other hand, in a case where the voltage of the data signal Vid is converted into the negative polarity, the voltage becomes a voltage that swings from the voltage Vb (−) to the higher electric potential side.

Since the scanning line positioned in the (i+240)-th row is selected before the scanning line positioned in the i-th row in the first field, during a period during which the scanning signal G (i+240) is in the H level, for example, during a period during which the sampling signal 51 is in the H level, the data signal Vid becomes a voltage having the negative polarity that corresponds to the gray scale of the pixel of the i-th row and the first column. Thereafter, the data signal Vid changes to voltages having the negative polarity that correspond to the gray scales of the pixels positioned in the second, third, fourth, . . . , and 640th columns in accordance with a change in the sampling signal.

Since the positive polarity writing is designated in the i-th row that is selected thereafter, during a period during which the scanning signal Gi is in the H level, for example, during a period during which the sampling signal S1 is in the H level, the data signal Vid becomes a voltage having the positive polarity that corresponds to the gray scale of the pixel positioned in the i-th row and the first column and thereafter changes to a voltage having the positive polarity that corresponds to the gray scales of the pixels positioned in the second, third, fourth, . . . , 640th columns in accordance with a change in the sampling signal.

In addition, since the scanning line positioned in the (i+240)-th row is selected after the scanning line positioned in the i-th row in the second field, the scanning signal G1 is in the H level first, and the writing polarity is inverted. Accordingly, the voltage waveform of the data signal Vid is as shown in FIG. 6.

In FIGS. 5 and 6, for the convenience of the description, the vertical scale representing the voltage of the data signal Vid is larger than those of the other signals. In addition, during a period during until the sampling signal S1 changes to the H level after the sampling signal S640 changes to the L level, a voltage corresponding to a black color is set. The reason for this is that even if a voltage is incorrectly written into the pixel, the voltage does not contribute to a display due to mismatching of timing or the like.

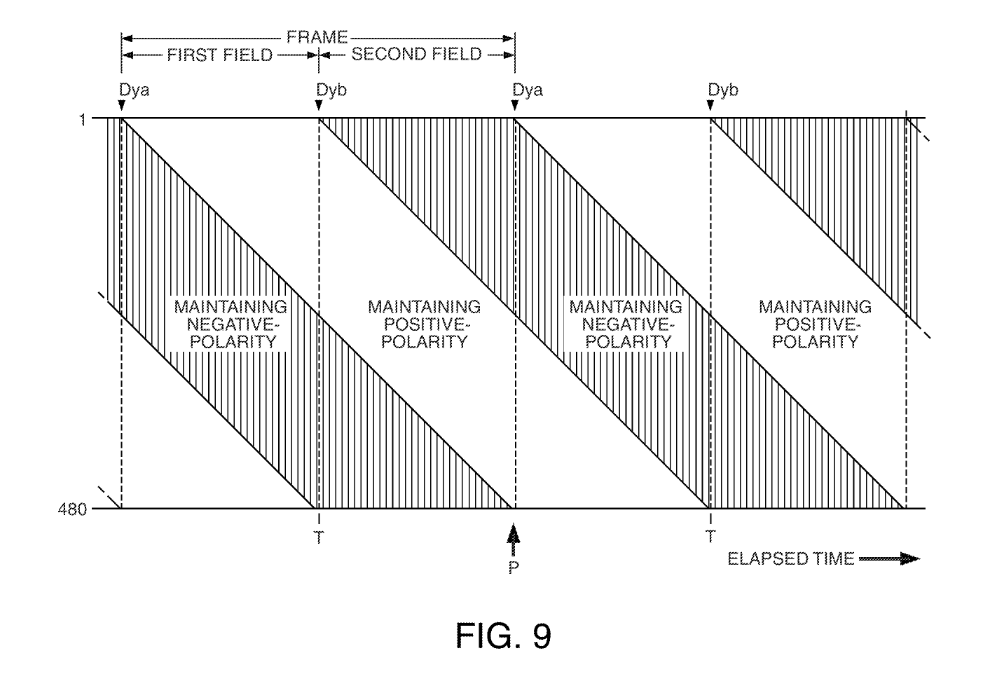

Next, FIG. 9 is a diagram showing the writing state of each row with an elapse of time over continuous frames in a case where the start pulse Dyb is supplied at timing T. As shown in the figure, according to this embodiment, in the first field, negative polarity writing is performed for the pixels of the 241st, 242nd, 243rd, . . . , 480th rows, positive-polarity writing is performed for the pixels of the first, second, third, . . . , 240th rows, and the states are maintained until the next writing. In addition, in the second field, negative-polarity writing is performed for the pixels of the first, second, third, . . . , 240th rows, positive-polarity writing is performed for the pixels of the 241st, 242nd, 243rd, . . . , 480th rows, and, similarly, the states are maintained until the next writing.

When the value of the register is “0”, and the start pulse Dyb is supplied at timing T, the periods of the first and second fields respectively correspond to 240 cycles of the clock signals Cly, and a period during which a voltage having the positive polarity is maintained in the liquid crystal capacitor 120 and a period during which a voltage having the negative polarity is maintained therein are a half of the frame period, respectively in each pixel.

Then, the voltage LCcom applied to the opposing electrode 108, as shown in FIG. 5, is set to an electric potential that is lower than the reference voltage Vc at the time of factory shipment. The reason for this is that so-called push-down and the like occur and leakage of the liquid crystal capacitor differs in a case where a voltage having the positive polarity is maintained and a case where a voltage having the negative polarity is maintained, in an active matrix-type electro-optical device in which a pixel electrode is driven by a TFT.

When the voltage LCcom is set so as to coincide with the reference voltage Vc, the effective value of the voltage of the liquid crystal capacitor 120 according to negative-polarity writing is slightly greater than the effective value according to the positive-polarity writing (the TFT 116 is the n-channel type). Accordingly, the voltage LCcom is set so as to be offset to the side of an electric potential that is lower than the reference voltage Vc to an optimized value for offsetting the difference.

According to this embodiment, when the start pulse Dyb is supplied at timing T, the periods of the first and second fields are the same, and each of the period during which a voltage having the positive polarity is maintained and the period during which a voltage having the negative polarity is maintained in the liquid crystal capacitor 120 of each pixel is a half of the frame period. Accordingly, a DC component is not applied to the liquid crystal capacitor 120. However, when the amount of push-down of the TFT or the amount of leakage in the liquid crystal capacitor changes over time from that at the time of factory shipment, the voltage LCcom is not an optimized value anymore. Therefore, a DC component is applied to the liquid crystal capacitor 120, and flicker is generated. Thus, in this embodiment, in order to suppress the generation of flicker, the timing of the start pulse Dyb is changed in correspondence with the set value stored in the register, and whereby application of a DC component to the liquid crystal capacitor 120 is controlled.

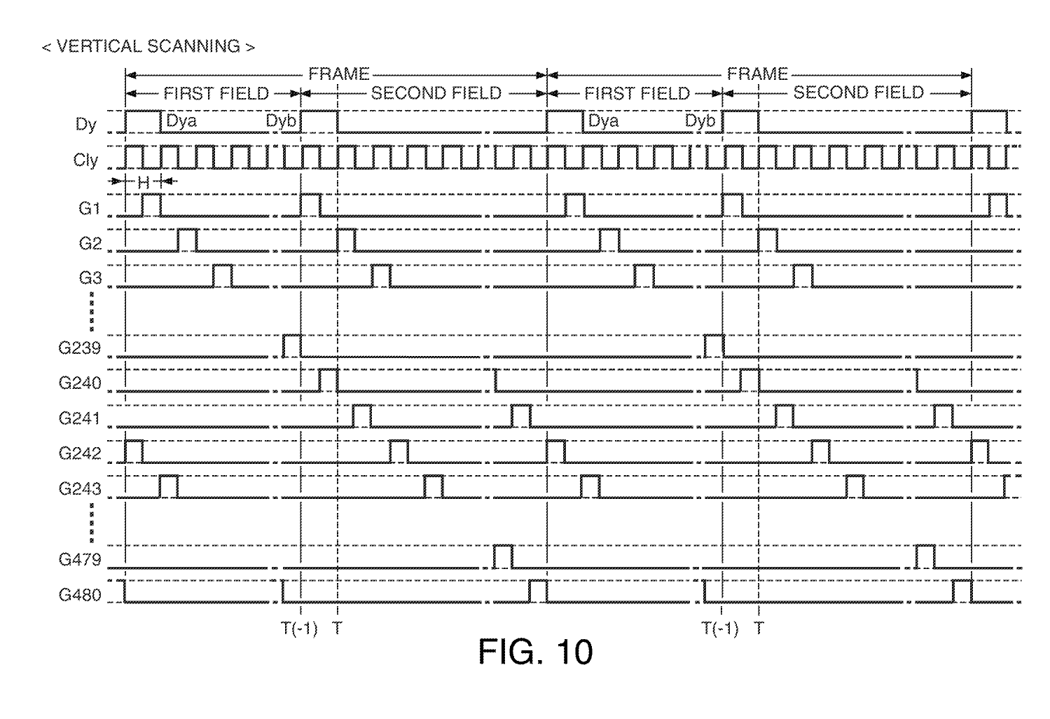

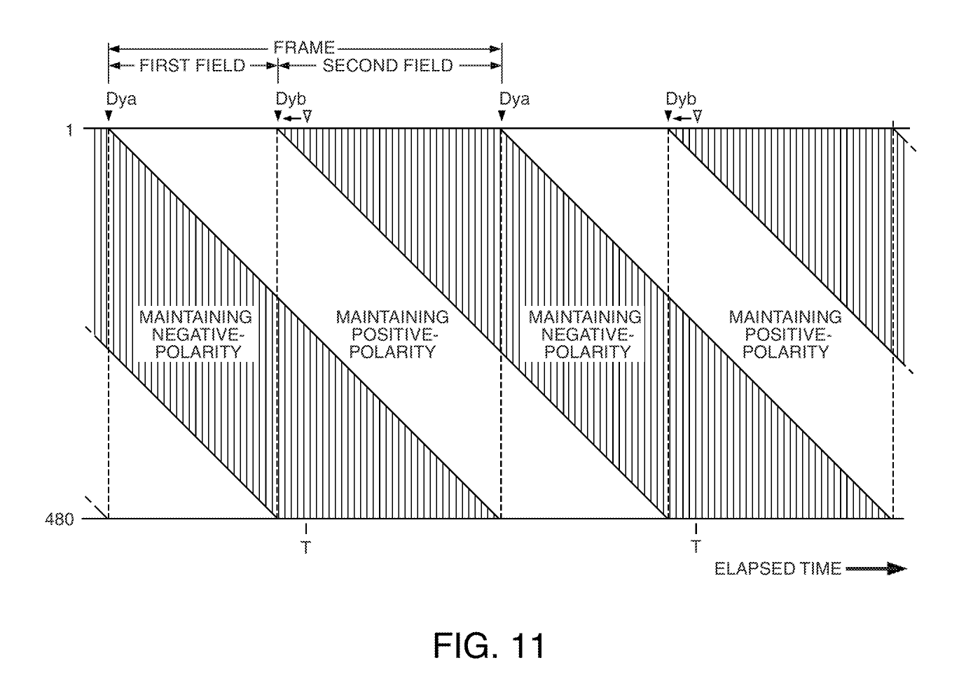

For example, when the value stored in the register is “−1”, the control circuit 52, as shown in FIG. 10, changes the timing of the start pulse Dyb to timing T(−1) that is advanced from the timing T by one cycle of the clock signal Cly and outputs the start pulse Dyb at the changed timing. Then, the period of the first field corresponds to 239 cycles of the clock signal Cly, and the period of the second field corresponds to 241 cycles of the clock signal Cly. Accordingly, as shown in FIG. 11, the maintaining period of the voltage having the negative polarity that is written through selection triggered by supply of the start pulse Dyb is longer than the maintaining period of the voltage having the positive polarity that is written through selection triggered by supply of the start pulse Dya. Therefore, the effective value of the voltage maintained in the pixel in accordance with a voltage having the negative polarity increases, and the effective value of the voltage maintained in the pixel in accordance with a voltage having the positive polarity decreases.

When the effective value of the voltage that is maintained in accordance with the voltage having the negative polarity is greater than the effective value of the voltage maintained in accordance with the voltage having the positive polarity, the pixel changes to be brightened when the voltage having the negative polarity is maintained and darkened when the voltage having the positive polarity is maintained. In addition, when the value stored in the register is “−2”, the control circuit 52 changes the timing of the start pulse Dyb to timing that is advanced from the timing T by two cycles of the clock signal Cly and outputs the start pulse Dyb at the changed timing. Then, in the pixel, compared to a case where the value stored in the register is “−1”, the effective value of the voltage maintained in accordance with the voltage having the negative polarity additionally increases, and the effective value of the voltage maintained in accordance with the voltage having the positive polarity additionally decreases.

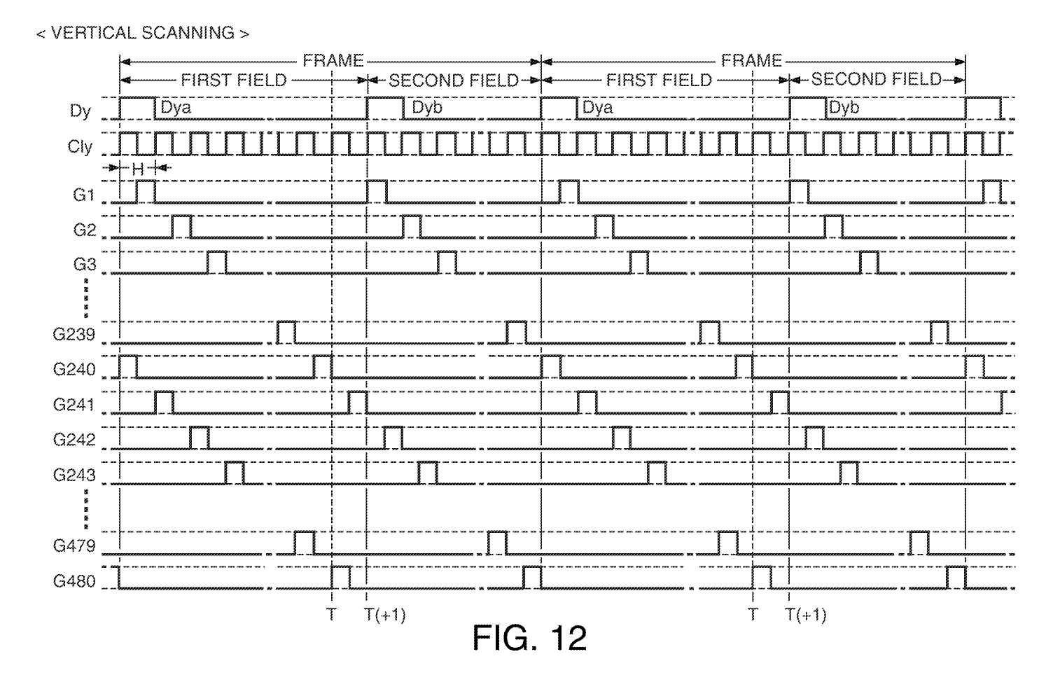

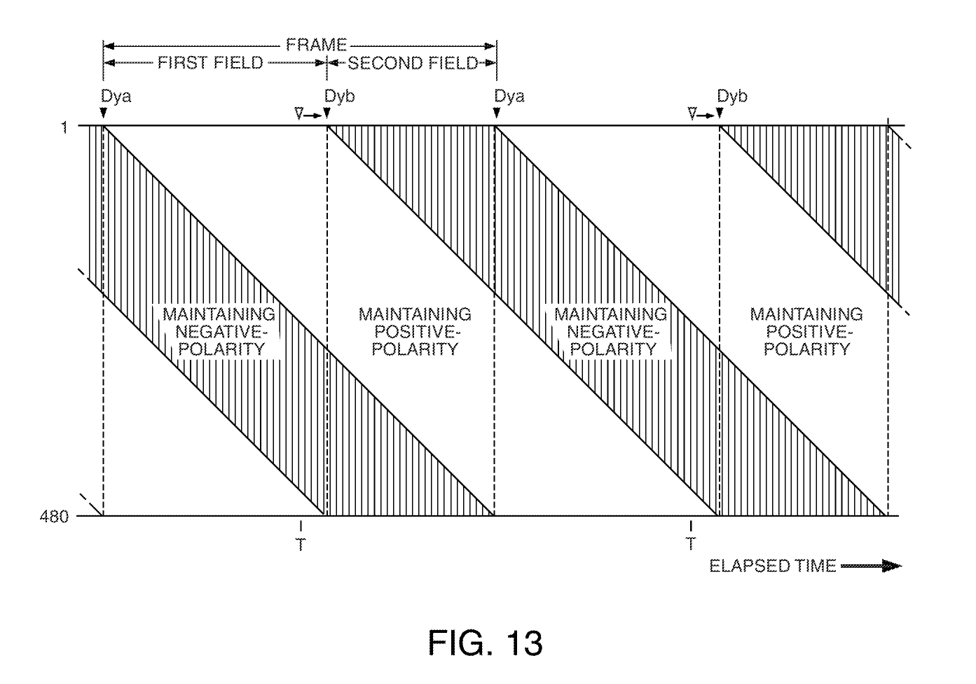

On the other hand, when the value stored in the register is “+1”, the control circuit 52, as shown in FIG. 12, changes the timing of the start pulse Dyb to timing T(+1) that is delayed from the timing T by one cycle of the clock signal Cly and outputs the start pulse Dyb at the changed timing. Then, the period of the first field corresponds to 241 cycles of the clock signal Cly, and the period of the second field corresponds to 239 cycles of the clock signal Cly. Accordingly, as shown in FIG. 13, the maintaining period of the voltage having the negative polarity that is written through selection triggered by supply of the start pulse Dyb is shorter than the maintaining period of the voltage having the positive polarity that is written through selection triggered by supply of the start pulse Dya. Therefore, the effective value of the voltage maintained in the pixel in accordance with a voltage having the positive polarity increases, and the effective value of the voltage maintained in the pixel in accordance with a voltage having the negative polarity decreases.

When the effective value of the voltage that is maintained in accordance with the voltage having the positive polarity is greater than the effective value of the voltage maintained in accordance with the voltage having the negative polarity, the pixel changes to be brightened when the voltage having the positive polarity is maintained and darkened when the voltage having the negative polarity is maintained. In addition, when the value stored in the register is “+2”, the control circuit 52 changes the timing of the start pulse Dyb to timing that is delayed from the timing T by two cycles of the clock signal Cly and outputs the start pulse Dyb at the changed timing. Then, in the pixel, compared to a case where the value stored in the register is “+1”, the effective value of the voltage maintained in accordance with the positive polarity additionally increases, and the effective value of the voltage maintained in accordance with the negative polarity additionally decreases.

In this embodiment, the electro-optical device 1 detects a case where the pixel is brightened (darkened) out of a case where the pixel maintains a voltage having the positive polarity and a case where the pixel maintains a voltage having the negative polarity. By detecting a case where the pixel is brightened out of the case where a voltage having the positive polarity is maintained and the case where a voltage having the negative polarity is maintained, a case where the effective value of the voltage increases out of the case where a voltage having the positive polarity is maintained and the case where a voltage having the negative polarity is maintained can be known.

According to the electro-optical device 1, by controlling the output timing of the start pulse, depending on the detection result, such that a period during which the effective value of a voltage is higher out of the period for maintaining a voltage having the positive polarity and the period for maintaining a voltage having the negative polarity becomes shorter, a DC component applied to the liquid crystal capacitor 120 is suppressed by controlling the effective values of voltages having the positive polarity and the negative polarity. In addition, a difference between the brightness levels of the pixel in a case where the voltage having the positive polarity is maintained and in a case where the voltage having the negative polarity is maintained is suppressed.

Hereinafter, an operation of controlling the output timing of the start pulse will be described.

First, when starting the operation of the display panel 10, the control circuit 52 stores the first set value in the register. Next, when a synchronization signal Vsync and a display data Video are supplied to the processing circuit 50 from the external high-level device, the data signal Vid is supplied to the display panel 10. Since the pixel of the 480th row is a detection pixel that is used for measuring the brightness of the pixel by the optical sensor 71, the display data processing circuit 54 supplies the data signal Vid such that the pixel of the 480th row consistently has a halftone gray scale between a maximum gray scale of white and a minimum gray scale of black regardless of the gray scale designated in accordance with the display data Video.

In addition, the control circuit 52 drives the display panel 10 in correspondence with the supplied synchronization signal Vsync. Here, since the value that is stored in the register is the first set value, that is, a negative value, the control circuit 52 outputs the start pulse Dyb at timing that is advanced from the timing T. Here, the timing that is advanced from the timing T is timing that is advanced from the timing T by n cycles of the clock signal Cly (here, n is a value that is stored in the register).

When the display panel 10 is driven, the brightness of the pixel of the 480th row is measured by the optical sensor 71, and a signal Sb is supplied to the data analyzing unit 72. The data analyzing unit 72 detects a brighter case out of a case where a voltage having the positive polarity is maintained by the pixel and a case where a voltage having the negative polarity is maintained by the pixel based on the signal Sb and outputs a signal Sa2 to the control circuit 52. In addition, the data analyzing unit 72 converts the signal into a digital signal Sdb and performs a fast Fourier transform so as to detect a difference between the brightness level at a time when the pixel maintains a voltage having the positive polarity and the brightness level at a time when the pixel maintains a voltage having the negative polarity. The data analyzing unit 72 outputs a signal Sa1 representing the detected difference of the brightness levels to the control circuit 52.

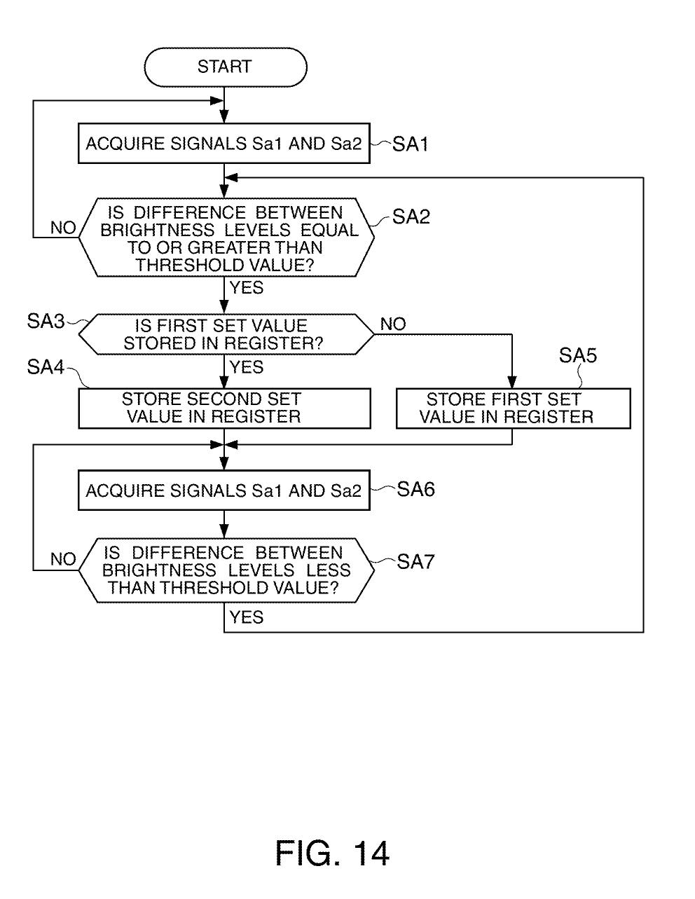

Thereafter, the control circuit 52 operates in accordance with a flowchart shown in FIG. 14. First, the control circuit 52 acquires the signal Sa1 and the signal Sa2 that are supplied form the data analyzing unit 72 (Step SA1). The control circuit 52 acquires a difference between the brightness level at a time when a voltage having the positive polarity is maintained by the pixel and the brightness level at a time when a voltage having the negative polarity is maintained by the pixel based on the acquired signal Sa1. Next, the control circuit 52 determines whether or not the difference in the brightness levels is equal to or greater than a predetermined threshold value. Here, the threshold value is set as a value that represents a difference between the brightness levels that is not recognized as flicker when a user sees the display panel 10. When the difference between the brightness levels is less than the threshold value, that is, a state is formed in which the difference between the brightness levels is not recognized as flicker (NO in Step SA2), the flow of the process is returned back to Step SA1 by the control circuit 52. Here, the control circuit 52 may be configured to return the flow of the process to Step SA1 after a predetermined time elapses (for example several seconds to several minutes).

When the output timing of the start pulse Dyb is advanced from the timing T, as described above, the effective value of the voltage maintained in the pixel in accordance with a voltage having the negative polarity increases, and the effective value of the voltage maintained in the pixel in accordance with a voltage having the positive polarity decreases. Accordingly, as time elapses, the pixel changes to be brightened when the voltage having the negative polarity is maintained, and is darkened when the voltage having the positive polarity is maintained. When a state is formed as time elapses in which the difference between the brightness levels is equal to or greater than the threshold value, that is, a state in which the difference between the brightness levels is recognized as flicker (YES in Step SA2), the control circuit 52 determines whether or not the value stored in the register is the first set value (Step SA3).

Here, as described above, the first set value is stored in the register. Accordingly, the control circuit 52 determines “YES” in Step SA3 and stores the second set value in the register (Step SA4). When the second set value is stored in the register, the second set value is a positive value, and accordingly, the control circuit 52 outputs the start pulse Dyb at timing that is delayed from the timing T. Here, the timing that is delayed from the timing T is timing that is delayed by n cycles of the clock signal Cly (here, n is a value stored in the register).

Next, the control circuit 52 acquires the signal Sa1 and the signal Sa2 that are supplied from the data analyzing unit 72 (Step SA6) and acquires the difference between the brightness level at a time when a voltage having the positive polarity is maintained by the pixel and the brightness level at a time when a voltage having the negative polarity is maintained by the pixel based on the acquired signal Sa1. Next, the control circuit 52 determines whether or not the difference between the brightness levels is less than the predetermined threshold value. When the difference between the brightness levels is equal to or greater than the threshold value (NO in Step SA7), the flow of the process is returned back to Step SA6 by the control circuit 52.

In addition, when the output timing of the start pulse Dyb is delayed from the timing T, as described above, the effective value of the voltage maintained in accordance with a voltage having the positive polarity increases in the pixel, and the effective value of the voltage maintained in accordance with a voltage having the negative polarity decreases in the pixel. Accordingly, as time elapses, the pixel changes so as to be brightened when a voltage having the positive polarity is maintained therein and darkened when a voltage having the negative polarity is maintained therein. Then, the difference between the brightness levels that is equal to or greater than the threshold value slowly decreases as time elapses. When a state is formed in which the difference between the brightness levels is less than the threshold value, that is, when a state is formed in which the difference between the brightness levels is not recognized as flicker after an elapse of time (YES in Step SA7), the control circuit 52 returns the flow of the process to Step SA2.

When returning the flow of the process back to Step SA2, the control circuit 52 repeats the process of Step SA1 and Step SA2 until the difference between the brightness levels is equal to or greater than the threshold value. While the process of Step SA1 and Step SA2 is repeated, in the pixel, the effective value of the voltage maintained in accordance with a voltage having the positive polarity increases, and the effective value of the voltage maintained in accordance with a voltage having the negative polarity decreases. Then, when time elapses and the relationship between the effective value of the voltage maintained in accordance with the voltage having the negative polarity and the effective value of the voltage maintained in accordance with the voltage having the positive polarity is reversed, the pixel is brightened when a voltage having the positive polarity is maintained, and the pixel is darkened when a voltage having the negative polarity is maintained.

When the difference between the brightness levels is equal to or greater than the threshold value and “YES” is determined in Step SA2, the control circuit 52 determines whether or not the value stored in the register is the first set value. Here, as described above, the second set value is stored in the register. Accordingly, the control circuit 52 determines “NO” in Step SA3 and stores the first set value in the register (Step SA5).

When the first set value is stored in the register, the control circuit 52 outputs the start pulse Dyb again at timing that is advanced from the timing T. Accordingly, in the pixel, the effective value of the voltage maintained in accordance with a voltage having the negative polarity increases, and the effective value of the voltage maintained in accordance with a voltage having the positive polarity decreases. Then, the difference in the brightness levels that has been equal to or greater than the threshold value slowly decreases as time elapses.

Next, the control circuit 52 acquires the signal Sa1 and the signal Sa2 that are supplied from the data analyzing unit 72 (Step SA6) and acquires a difference between the brightness level at a time when a voltage having the positive polarity is maintained by the pixel and the brightness level at a time when a voltage having the negative polarity is maintained based on the acquired signal Sa1. Next, when the difference between the brightness levels is less than the predetermined threshold value (YES in Step SA7), the control circuit 52 returns the flow of the process back to Step SA2.

Thereafter, the control circuit 52 repeats the process of Step SA1 to Step SA7. Then, when the difference between the brightness level at a time when a voltage having the positive polarity is maintained by the pixel and the brightness level at a time when a voltage having the negative polarity is maintained by the pixel is equal to or greater than the threshold value, the control circuit 52 changes the set value stored in the register. Accordingly, switching between a state in which the maintaining period of the voltage having the positive polarity increases and a state in which the maintaining period of the voltage having the negative polarity increases is performed, and the difference between the brightness levels of the pixel changes in a direction in which the difference decreases to be equal to or less than the threshold value. Therefore, generation of flicker can be suppressed.

In addition, the generation of flicker can be suppressed without adjusting the voltage applied to the electrode. Thus, a process for performing adjustment before shipment of the device is not necessary, power consumed in the adjustment before shipment can be suppressed, and the discharge amount of carbon dioxide due to the adjustment operation can be suppressed.

### Second Embodiment

Next, an electro-optical device 1 according to a second embodiment of the invention will be described. The hardware configuration of the electro-optical device 1 according to the second embodiment is the same as that according to the first embodiment. A difference between the electro-optical device 1 according to the second embodiment and the electro-optical device 1 according to the first embodiment is that the process performed by the control circuit 52 is different. Thus, hereinafter, the description will be presented with the difference mainly focused.

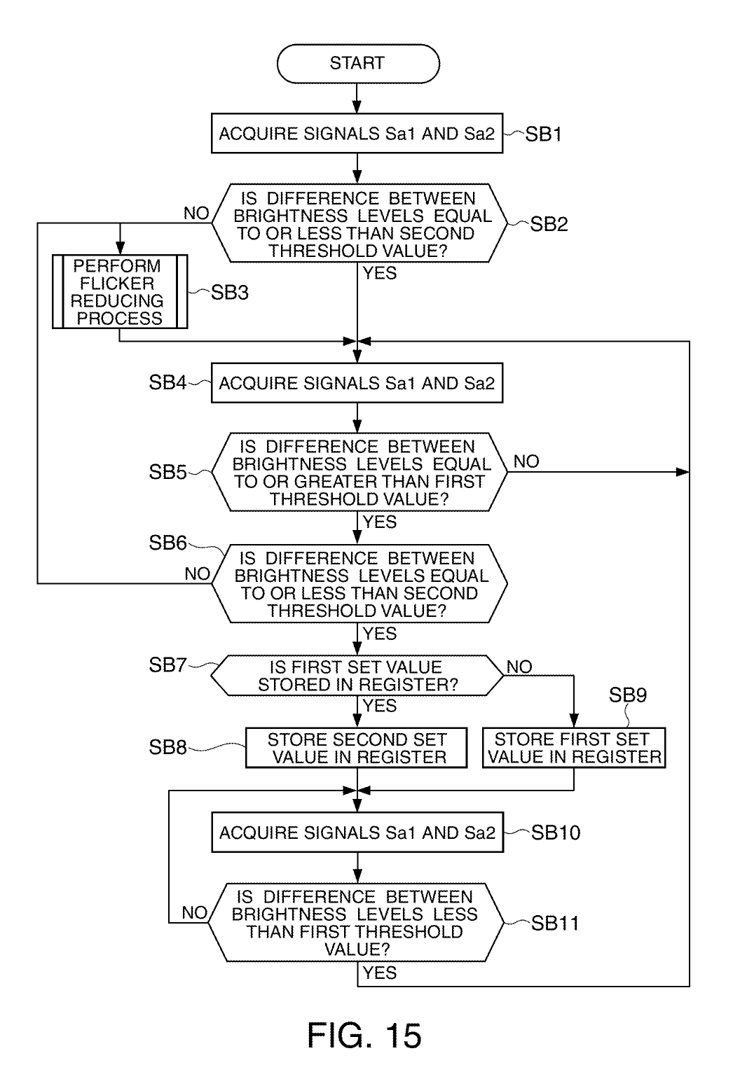

FIG. 15 is a flowchart showing the flow of the process that is performed by the control circuit 52 according to the second embodiment. In the control circuit 52, the process until Step SB1 after start of the operation of the display panel 10 is the same as that of the first embodiment.

First, the control circuit 52 acquires the signal Sa1 and the signal Sa2 that are supplied from the data analyzing unit 72 (Step SB1). When acquiring a difference between the brightness level at a time when a voltage having the positive polarity is maintained by the pixel and the brightness level at a time when a voltage having the negative polarity is maintained by the pixel based on the acquired signal Sa1, the control circuit 52 determines whether or not the difference in the brightness levels is equal to or greater than a second threshold value that is set in advance.

According to the second embodiment, the control circuit 52 includes the first and second threshold values, and the first threshold value is the same as that of the first embodiment. On the other hand, the second threshold value is a threshold value that is greater than the first threshold value.

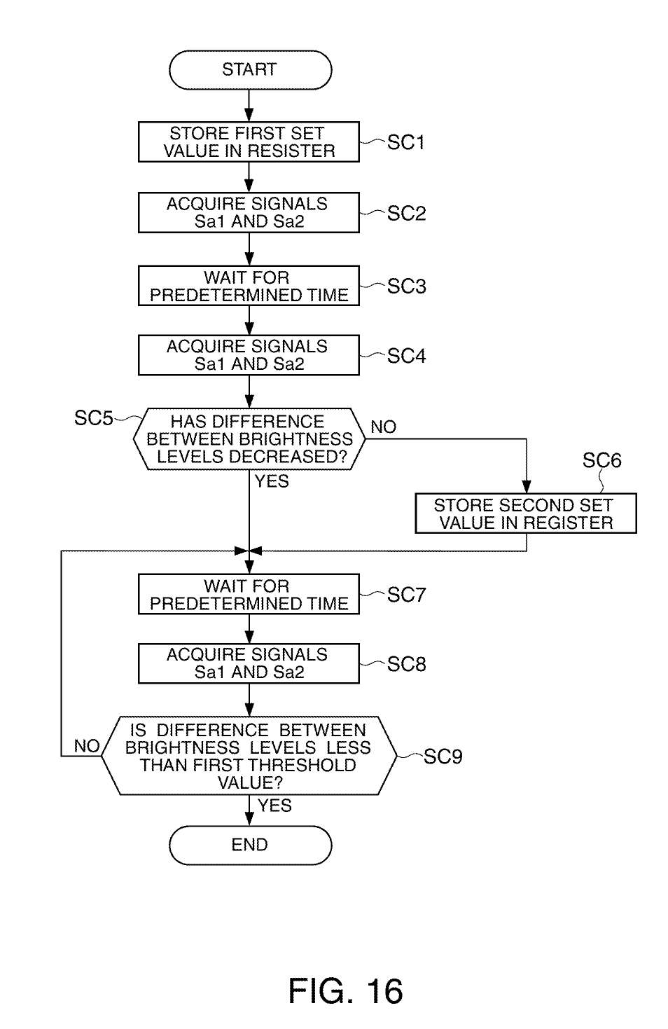

For example, when an excessive current flows through the display panel 10 due to power outage, a stroke of lightening, or the like, there is a possibility that electric charge inside the display panel 10 is markedly biased so as to make the difference between the brightness level at the time of maintaining a voltage having the positive polarity and the brightness level at the time of maintaining a voltage having the negative polarity much greater than the first threshold value. When the difference between the brightness level at the time of maintaining a voltage having the positive polarity and the brightness level at the time of maintaining a voltage having the negative polarity is quite large in the display panel 10 as described above (NO in Step SB2), the control circuit 52 performs a flicker reducing process that is shown in FIG. 16. On the other hand, when the difference in the brightness levels is equal to or less than the second threshold value (YES in Step SB2), the control circuit 52 does not perform flicker reducing process.

When performing the flicker reducing process, first, the control circuit 52 stores the first set value in the register (Step SC1). Thereafter, the control circuit 52 acquires signals Sa1 and Sa2 (Step SC2) and acquires the difference between the brightness at the time when a voltage having the positive polarity is maintained by the pixel and the brightness level at the time when a voltage having the negative polarity is maintained by the pixel based on the signal Sa1. Next, after waiting for predetermined time (Step SC3), the control circuit 52 acquires the signals Sa1 and Sa2 (Step SC4) and acquires the difference between the brightness level at the time when a voltage having the positive polarity is maintained by the pixel and the brightness level at the time when a voltage having the negative polarity is maintained by the pixel based on the signal Sa1.

The control circuit 52 compares the difference between the brightness levels that is acquired in Step SC2 and the difference between the brightness levels that is acquired in Step SC4. When the difference between the brightness levels that is acquired in Step SC4 is not smaller than the difference between the brightness levels that is acquired in Step SC2 (NO in Step SC5), the second set value is stored in the register (Step SC6). On the other hand, when the difference between the brightness levels that is acquired in Step SC4 is smaller than the difference between the brightness levels that is acquired in Step SC2 (YES in Step SC5), the first set value is maintained to be stored in the register.

Next, after waiting for predetermined time (Step SC7), the control circuit 52 acquires the signals Sa1 and Sa2 (Step SC8) and acquires the difference between the brightness level at the time when a voltage having the positive polarity is maintained by the pixel and the brightness level at the time when a voltage having the negative polarity is maintained by the pixel based on the signal Sa1. The control circuit 52 determines whether or not the acquired difference between the brightness levels is less than the first threshold value set in advance. When the difference between the brightness levels is equal to or greater than the first threshold value (NO in Step SC9), the control circuit 52 returns the flow of the process back to Step SC7. On the other hand, when the difference between the brightness levels is less than the first threshold value (YES in Step SC9), the flicker reducing process is completed.

When the flicker reducing process is completed or “YES” is determined in Step SB2, the control circuit 52 acquires the signals Sa1 and Sa2 (Step SB4) and acquires a difference between the brightness level at a time when a voltage having the positive polarity is maintained by the pixel and the brightness level at a time when a voltage having the negative polarity is maintained by the pixel based on the signal Sa1. Next, when the difference between the brightness levels is less than the first threshold value (NO in Step SB5), the control circuit 52 returns the flow of the process back to Step SB4. On the other hand, when the difference between the brightness levels is equal to or greater than the first threshold value (YES in Step SB5), the control circuit 52 determines whether or not the difference between the brightness levels is equal to or less than the second threshold value.

Here, when the difference between the brightness levels exceeds the second threshold value (NO in Step SB6), the control circuit 52 returns the flow of the process back to Step SB3. On the other hand, when the difference between the brightness levels is equal to or less than the second threshold value (YES in Step SB6), the control circuit 52 determines whether or not the value stored in the register is the first set value.

Here, when the value stored in the register is the first set value, the second set value is stored in the register (Step SB8). On the other hand, when the value stored in the register is the second set value, the first set value is stored in the register (Step SB9). Next, the control circuit 52 acquires the signals Sa1 and Sa2 that are supplied from the data analyzing unit 72 (Step SB10) and acquires a difference between the brightness level at a time when a voltage having the positive polarity is maintained by the pixel and the brightness level at a time when a voltage having the negative polarity is maintained by the pixel based on the acquired signal Sa1. Next, the control circuit 52 determines whether the difference between the brightness levels is less than the first threshold value.

When the difference between the brightness levels is equal to or greater than the first threshold value, that is, when a state is formed in which the difference between the brightness levels is recognized as flicker (NO in Step SB11), the control circuit 52 returns the flow of the process back to Step SB10. On the other hand, when the difference between the brightness levels is less than the first threshold value (YES in Step SB11), the control circuit 52 returns the flow of the process back to Step SB4 and advances the process.

According to this embodiment, even when the electric charge inside the display panel 10 is markedly biased so as to make the difference between the brightness level of the pixel at the time of maintaining a voltage having the positive polarity and the brightness level of the pixel at the time of maintaining a voltage having the negative polarity markedly large, first, the difference between the brightness levels is decreased as being less than the first threshold value through the flicker reducing process, and whereby flicker can be reduced.

### Third Embodiment

Next, an electro-optical device 1 according to a third embodiment of the invention will be described. The hardware configuration of the electro-optical device 1 according to the third embodiment is the same as that according to the first embodiment. A difference between the electro-optical device 1 according to the third embodiment and the electro-optical device 1 according to the first or second embodiment is that the process performed by the control circuit 52 is different. Thus, hereinafter, the description will be presented with the difference mainly focused.

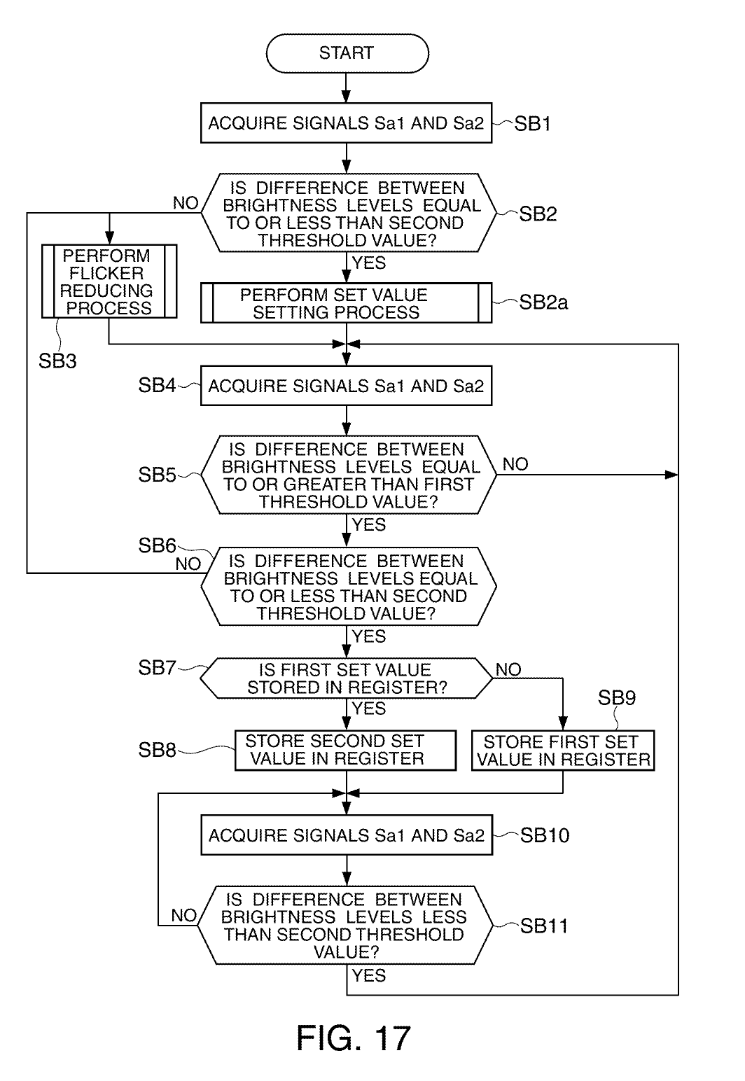

FIG. 17 is a flowchart showing the flow of the process that is performed by the control circuit 52 according to the third embodiment. In the third embodiment, Step SB2a is included, which is different from the second embodiment.

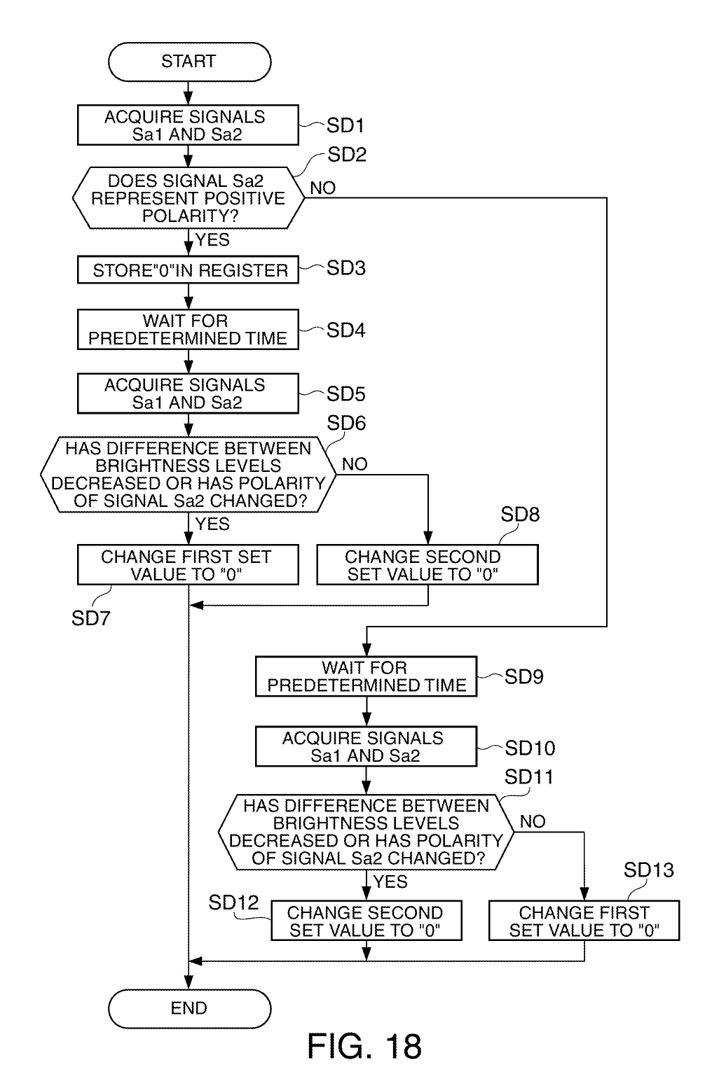

FIG. 18 is a flowchart representing the flow of a set value setting process performed in Step SB2a.

First, the control circuit 52 acquires signals Sa1 and Sa2 (Step SD1). When the acquired signal Sa2 represents the positive polarity (YES in Step SD2), the control circuit 52 stores “0” in the resister (Step SD3). Next, after waiting for predetermined time (Step SD4), the control circuit 52 acquires the signals Sa1 and Sa2 (Step SD5).

Next, the control circuit 52 compares the signal Sa1 acquired in Step SD1 and the signal Sa1 acquired in Step SD5 and determines whether the difference between the brightness levels of the pixel decreases after the predetermined time elapses. In addition, the control circuit 52 compares the signal Sa2 acquired in Step SD1 and the signal Sa2 acquired in Step SD5 and determines whether the polarity represented by the signal Sa2 changes after the predetermined time elapses.

When determining that the difference between the brightness levels of the pixel has decreased or the polarity changes (YES in Step SD6), the second set value is not changed, the control circuit 52 changes the value of the first set value from a positive value to “0” as a third set value and completes the process (Step SD7). On the other hand, when “NO” is determined in Step SD6, the control circuit 52 changes the value of the second set value to “0” as the third set value without changing the value of the first set value and completes the process (Step SD8).

In addition, when the signal Sa2 acquired in Step SD1 represents the negative polarity (NO in Step SD2), the control circuit 52 acquires the signals Sa1 and Sa2 (Step SD10) after waiting for predetermined time (Step SD9). The control circuit 52 determines whether or not the difference between the brightness levels of the pixel has decreased after the predetermined time elapses by comparing the signal Sa1 acquired in Step SD1 and the signal Sa1 acquired in Step SD10. In addition, the control circuit 52 determines whether or not the polarity represented by the signal Sa2 has been changed after the predetermined time elapses by comparing the signal Sa2 acquired in Step SD1 and the signal Sa2 acquired in Step SD10.

When determining that the difference between the brightness levels of the pixel has decreased or the polarity has been changed (YES in Step SD11), the control circuit 52 changes the value of the second set value from a negative value to “0” as the third set value without changing the first set value and completes the process (Step SD12). On the other hand, when determining “NO” in Step SD11, the control circuit 52 changes the value of the first set value to “0” as the third set value without changing the value of the second set value and completes the process (Step SD13).

In a case where the maintaining time of a voltage having the positive polarity and the maintaining time of a voltage having the negative polarity are changed by using the first set value having a negative value and the second set value having a positive value as in the first and second embodiments, the maintaining time is markedly changed in accordance with switching between the set values. Accordingly, there is a concern that a user may feel strangeness of the change in the brightness level due to abrupt change between the bright level at the time of maintaining a voltage having the positive polarity and the brightness level at the time of maintaining a voltage having the negative polarity.

On the other hand, according to this embodiment, since one of the first set value and the second set value is “0”, the change in the voltage maintaining time due to switching between the set values becomes smaller than that of the first embodiment or the second embodiment. Accordingly, the change in the difference between the brightness level at the time of maintaining a voltage having a positive polarity and the brightness level at the time of maintaining a voltage having the negative polarity becomes gentle, and whereby the possibility for the user to feel strangeness of the change in the brightness level can be decreased.

### Fourth Embodiment

Next, an electro-optical device 1 according to a fourth embodiment of the invention will be described. The hardware configuration of the electro-optical device 1 according to the fourth embodiment is the same as that according to the first embodiment. A difference between the electro-optical device 1 according to the fourth embodiment and the electro-optical devices 1 according to the first to third embodiments is that the process performed by the control circuit 52 is different. Thus, hereinafter, the description will be presented with the difference mainly focused.

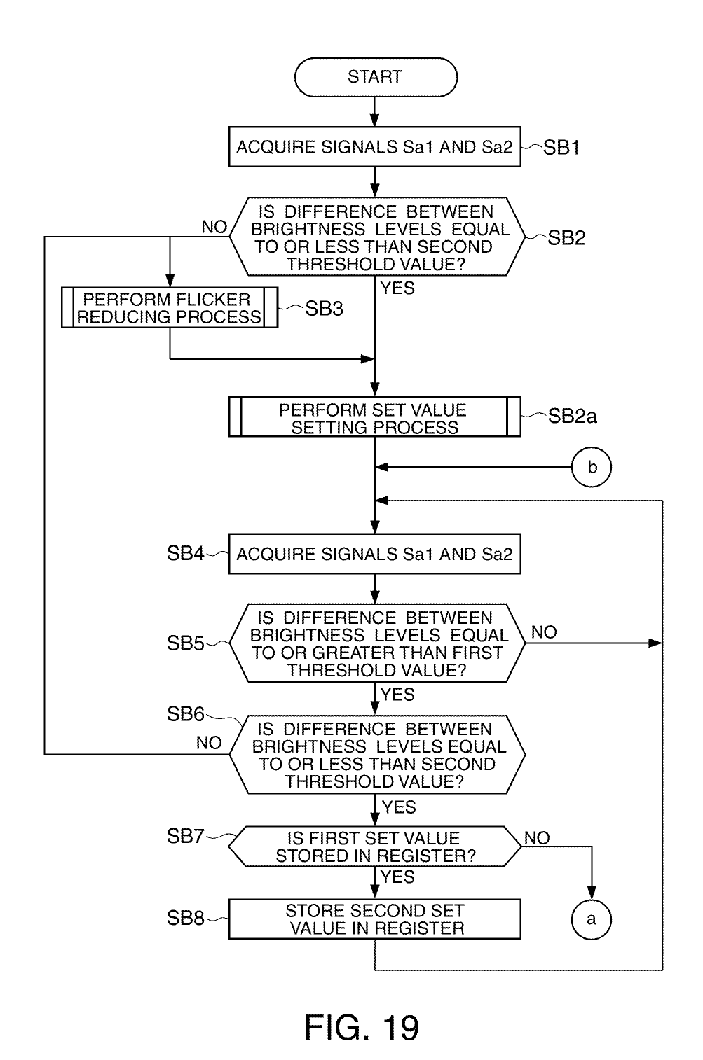

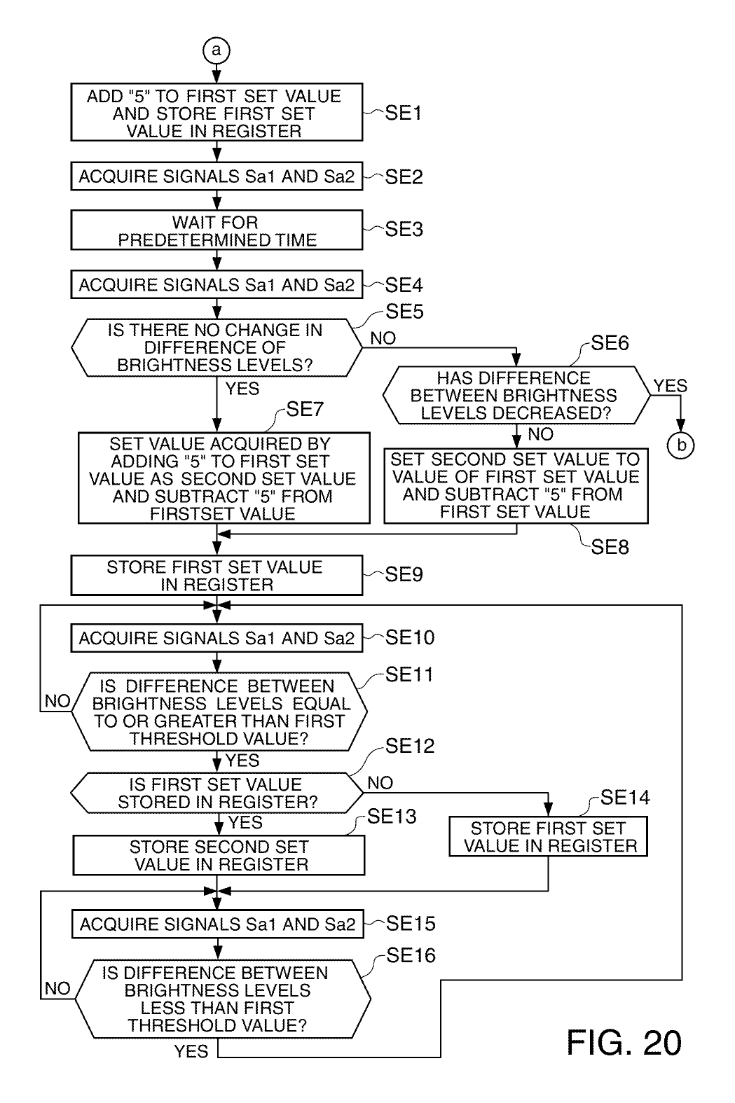

FIG. 19 is a flowchart showing the flow of the process that is performed by the control circuit 52 according to the fourth embodiment. In the fourth embodiment, there are differences from the third embodiment in that the process of Step SB2a is performed after the process of Step SB3 is performed, a process shown in FIG. 20 is performed in a case where “NO” is determined in Step SB7, and the flow of the process is returned back to Step SB4 after the process of Step SB8 is performed.

FIG. 20 is a flowchart representing the flow of the process that is performed when “NO” is determined in Step SB7. When determining “NO” in Step SB7, first, the control circuit 52 adds “5” to the value of the first set value, stores the first set value in the register, and drives the display panel 10 (Step SE1). Next, after acquiring the signals Sa1 and Sa2 (Step SE2), the control circuit 52 waits for predetermined time (Step SE2), and acquires the signals Sa1 and Sa2 again (Step SE4).

Next, the control circuit 52 compares the signal Sa1 acquired in Step SE2 and the signal Sa1 acquired in Step SE4 and determines whether there is a change in the difference between the brightness levels of the pixel after the predetermined time elapses. Here, when there is the change in the difference between the brightness levels of the pixels (“NO” in Step SE5), next, the control circuit 52 determines whether the difference between the brightness levels of the pixel has decreased. Here, when the difference between the brightness levels has decreased (YES in Step SE6), the control circuit 52 returns the flow of the process back to Step SB4. On the other hand, when the difference between the brightness levels has not decreased (NO in Step SE6), the value of the first set value is set as the second set value, “5” is subtracted from the first set value (Step SE8), and the flow of the process proceeds to Step SE9. On the other hand, when “YES” is determined in Step SE5, the control circuit 52 sets a value acquired by adding “5” to the first set value as the second set value, subtracts “5” from the first set value (Step SE7), and the flow of the process proceeds to Step SE9.

The control circuit 52, in Step SE9, stores the first set value in the register and drives the display panel 10. Next, after acquiring the signals Sa1 and Sa2 (Step SE10), the control circuit 52 acquires a difference between the brightness level at a time when a voltage having the positive polarity is maintained by the pixel and the brightness level at a time when a voltage having the negative polarity is maintained by the pixel based on the signal Sa1. Next, when the difference between the brightness levels of the pixel is less than the first threshold value (NO in Step SE11), the control circuit 52 returns the flow of the process back to Step SE10. On the other hand, when the difference between the brightness levels is equal to or greater than the first threshold value (YES in Step SB11), the control circuit 52 determines whether or not the first set value is stored in the register.

Here, when the value stored in the register is the first set value (YES in Step SE12), the second set value is stored in the register (Step SE13). On the other hand, when the value stored in the register is the second set value (NO in Step SE12), the first set value is stored in the register (Step SE14). Next, the control circuit 52 acquires the signals Sa1 and Sa2 that are supplied from the data analyzing unit 72 (Step SE15) and acquires a difference between the brightness level at a time when a voltage having the positive polarity is maintained by the pixel and the brightness level at a time when a voltage having the negative polarity is maintained by the pixel based on the acquired signal Sa1.

Next, the control circuit 52 determines whether the difference between the brightness levels is less than the first threshold value set in advance. When the difference between the brightness levels is equal to or greater than the first threshold value, that is, when a state is formed in which the difference between the brightness levels is recognized as flicker (NO in Step SE16), the flow of the process is returned back to Step SE15. On the other hand, when the difference between the brightness levels is less than the first threshold value (YES in Step SE16), the control circuit 52 returns the flow of the process back to Step SE10.

According to this embodiment, the first set value is automatically set to a value that is less than a set value for which there is no difference between the brightness level of the pixel at the time of maintaining a voltage having the positive polarity and the brightness level of the pixel at the time of maintaining a voltage having the negative polarity, and the second set value is automatically set to a value that is greater than a set value for which there is no difference between the brightness levels of the pixel. Therefore, the difference between the brightness levels decreases, and whereby the generation of flicker can be suppressed.

### Electronic Apparatus

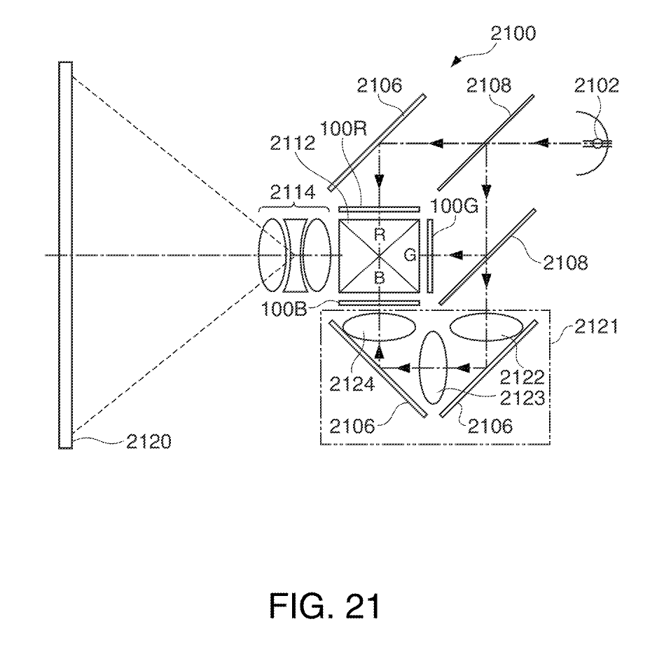

Next, an example of an electronic apparatus using the electro-optical device according to the above-described embodiments will be described. FIG. 21 is a plan view showing the configuration of a three plate-type projector that uses the display panel 10 of the above-described electro-optical devices 1 as a light valve.

In this projector 2100, light to be incident to the light valve is divided into light of three primary colors of R (red), G (green), and B (blue) by three mirrors 2106 and two dichroic mirrors 2108 that are disposed inside thereof and is guided to light valves 100R, 100G, and 100B corresponding to the primary colors. The light path for light of the B color is longer than that for the light of the R color or the G color. Thus, in order to prevent the loss, the light of the B color is guided through a relay lens system 2121 that is configured by an incident lens 2122, a relay lens 2123, and an outgoing lens 2124.

Here, the configuration of the light valves 100R, 100G, and 100B is the same as that of the display panel 10 according to the above-described embodiment, and the light valves are driven in accordance with image data corresponding to the colors R, G, and B supplied from an external higher device (not shown).

The light modulated by the light valves 100R, 100G, and 100B is incident to a dichroic prism 2112 from three directions. Then, in the dichroic prism 2112, light of the R color and light of the B color are refracted by 90 degrees, and light of the G color travels in a straight line. After images of each color are composed, a composed image is normally rotated and projected in an enlarged scale by a lens unit 1820, and whereby a color image is displayed on a screen 2120.

While transmission images of the light valves 100R and 100B are projected after being reflected by the dichroic prism 2112, the light valve 100G directly projects a transmission image. Accordingly, the images formed by the light valves 100R and 100B and the image formed by the light valve 100G have the horizontally reversed relationship.

In addition to the electronic apparatus described with reference to FIG. 21, as examples of the electronic apparatus, there are a rear projection-type television set and a direct-viewing type apparatus such as a cellular phone, a personal computer, a monitor of a video camera, a car navigation equipment, a pager, an electronic organizer, an electronic calculator, a word processor, a workstation, a television phone, a POS terminal, a digital still camera, and an apparatus including a touch panel. It is apparent that an electro-optical device according to an embodiment of the invention can be applied to such various electronic apparatuses.

### Modified Examples

As above, the embodiments of the invention have been described. However, the invention is not limited to the above-described embodiments, and various changes can be made therein. For example, the above-described embodiments may be modified as below for implementing the invention. In addition, the above-described embodiments and modified examples described below may be combined together.

In each of the above-described embodiments, a normally white mode in which white is displayed with no application of a voltage is employed. However, a normally black mode in which black is displayed with no application of a voltage may be employed.

In the above-described embodiments, the brightness of the pixel positioned in the 480th row is detected by the optical sensor 71. However, the pixel of which the brightness is detected is not limited to the pixel positioned in the 480th row, and a pixel positioned in any other row may be used.

In the above-described embodiments, the voltage LCcom is set in advance such that a difference between the brightness levels of the pixel during the initial period of a driving operation is within a predetermined range. However, in a case where there are individual variations, there is a concern that the generation of flicker cannot be suppressed by using such setting. Thus, in the electro-optical device 1, it may be configured that a sequence, in which the voltage LCcom is set so as to suppress the generation of flicker during the initial period of the driving operation, is arranged, and thereafter, an operation for controlling the output timing of the start pulse is performed.

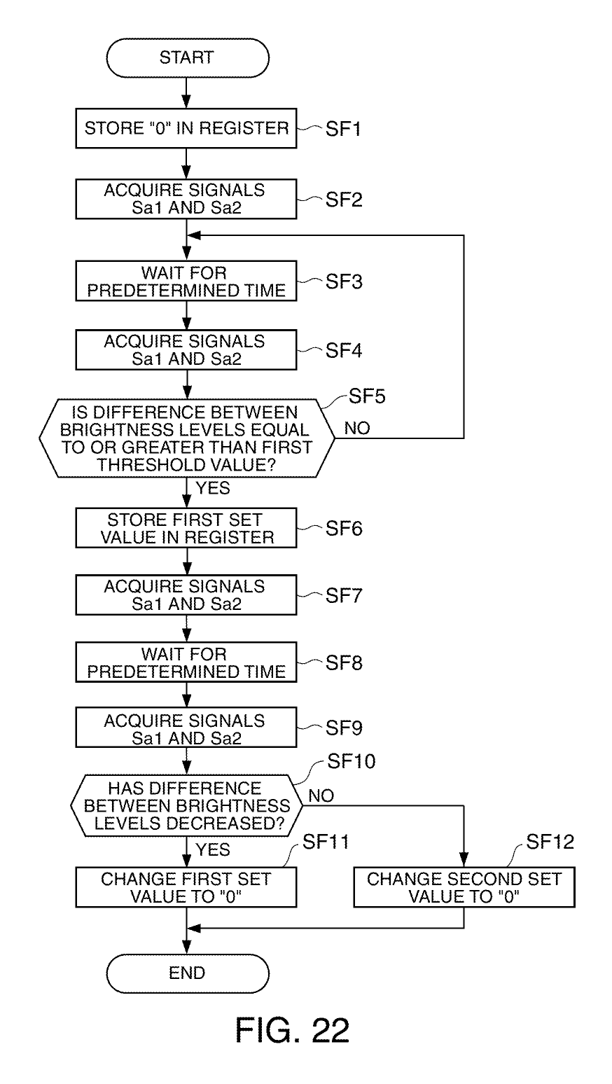

In the set value setting process of the third embodiment, the first set value and the second set value may be set by using a difference between the brightness levels of the pixel. FIG. 22 is a flowchart showing the flow of the process in a case where the set value setting process is performed by using the difference between the brightness levels of the pixel.

In addition, in the third embodiment, in a case where the process shown in FIG. 22 is performed as the set value setting process, the control circuit 52 performs a flicker reducing process even after determining “YES” in Step SB2.

When starting the set value setting process shown in FIG. 22, the control circuit 52 according to this modified example, first, stores “0” in the register (Step SF1). Thereafter, the control circuit 52 acquires the signals Sa1 and Sa2 (Step SF2) and acquires a difference between the brightness level at a time when the pixel maintains a voltage having the positive polarity and the brightness level at a time when the pixel maintains a voltage having the negative polarity based on the signal Sa1. Next, after waiting for predetermined time (Step SF3), the control circuit 52 acquires the signals Sa1 and Sa2 (Step SF4) and acquires a difference between the brightness level at a time when the pixel maintains a voltage having the positive polarity and the brightness level at a time when the pixel maintains a voltage having the negative polarity based on the signal Sa1. When the difference between the brightness levels that is acquired in Step SF4 is less than the first threshold value, the control circuit 52 returns the flow of the process back to Step SF3. On the other hand, when the difference between the brightness levels that is acquired in Step SF4 is equal to or greater than the first threshold value, the control circuit 52 stores the first set value in the register (Step SF6).

Thereafter, the control circuit 52 acquires the signals Sa1 and Sa2 (Step SF7) and acquires a difference between the brightness level at a time when the pixel maintains a voltage having the positive polarity and the brightness level at a time when the pixel maintains a voltage having the negative polarity based on the signal Sa1. Next, after waiting for predetermined time (Step SF8), the control circuit 52 acquires the signals Sa1 and Sa2 (Step SF9) and acquires a difference between the brightness level at a time when the pixel maintains a voltage having the positive polarity and the brightness level at a time when the pixel maintains a voltage having the negative polarity based on the signal Sa1.

Next, the control circuit 52 compares the difference of the brightness levels that is acquired in Step SF7 and the difference between the brightness levels that is acquired in Step SF9. When the difference between the brightness levels that is acquired in Step SF9 is not smaller than the difference of the brightness levels that is acquired in Step SF7 (NO in Step SF10), the second set value is set to “0” (Step SF12). On the other hand, when the difference between the brightness levels that is acquired in Step SF9 is smaller than the difference of the brightness levels that is acquired in Step SF7 (YES in Step SF10), the control circuit 52 sets the first set value to “0” (Step SF11).

In the above-described fourth embodiment, when “NO” is determined in Step SB7, the value of the first set value is changed, and the first set value and the second set value are set with the first set value used as a reference. However, it may be configured that the second set value is changed, and the first set value and the second set value are set with the changed second set value used as a reference.

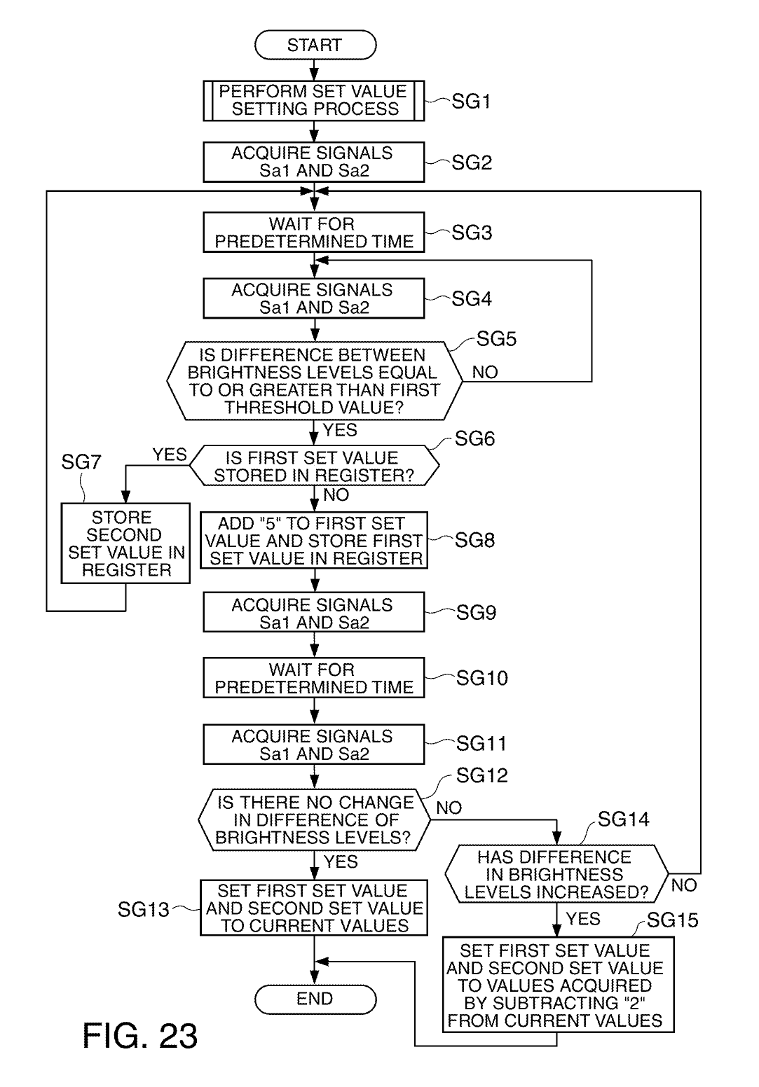

In the electro-optical device 1 according to an embodiment of the invention, the first set value and the second set value may be set by adjustment that is performed by the electro-optical device 1. FIG. 23 is a flowchart showing the flow of the adjustment process.

When this adjustment process is performed, the control circuit 52, first, performs the set value setting process shown in FIG. 18 or 22 (Step SG1).

Next, the control circuit 52 acquires the signals Sa1 and Sa2 (Step SG2) and acquires a difference between the brightness level at a time when the pixel maintains a voltage having the positive polarity and the brightness level at a time when the pixel maintains a voltage having the negative polarity based on the signal Sa1. Next, after waiting for predetermined time (Step SG3), the control circuit 52 acquires the signals Sa1 and Sa2 (Step SG4) and acquires a difference between the brightness level at a time when the pixel maintains a voltage having the positive polarity and the brightness level at a time when the pixel maintains a voltage having the negative polarity based on the signal Sa1.

Next, when the difference between the brightness levels that is acquired in Step SG4 is less than the first threshold value (NO in Step SG5), the control circuit 52 returns the flow of the process back to Step SG3. On the other hand, when the difference between the brightness levels that is acquired in Step SG4 is equal to or greater than the first threshold value (YES in Step SG5), the control circuit 52 determines whether the first set value is stored in the register.

Here, when the first set value is stored in the register, the control circuit 52 stores the second set value in the register (Step SG7) and returns the flow of the process back to Step SG2. On the other hand, when the second set value is stored in the register (NO in Step SG6), the control circuit 52 adds “5” to the value of the first set value, stores the first set value in the register, and drives the display panel 10 (Step SG8). Next, after acquiring the signals Sa1 and Sa2 (Step SG92), the control circuit 52 waits for predetermined time (Step SG10) and acquires the signals Sa1 and Sa2 again (Step SG11).

The control circuit 52 determines whether there is a change in the difference of the brightness level of the pixel after the predetermined time elapses by comparing the signal Sa1 acquired in Step SG9 and the signal Sa1 acquired in Step SG11. Here, when there is no change in the difference of brightness level of the pixel (YES in Step SG12), the control circuit 52 sets the first set value and the second set value to current values (Step SG13).

On the other hand, when determining “NO” in Step SG12, the control circuit 52 determines whether the difference between the brightness levels of the pixel is increased after predetermined time elapses. When there in an increase in the difference between the brightness levels (YES in Step SG14), “2” are subtracted from the second set value and the first set value, and then the values after the subtraction are set as the first set value and the second set value (Step SG15).

By setting the first set value and the second set value through such a process, the difference between the brightness levels is decreased, and whereby the generation of flicker can be suppressed.

According to an embodiment of the invention, the period lengths of the positive-polarity field and the negative-polarity field are controlled such that the difference between the brightness level at a time when the voltage having the positive polarity is maintained and the brightness level at a time when the voltage having the negative polarity is maintained is gradually changed in a predetermined range, based on the brightness level at a time when the pixel maintains a voltage having the positive polarity and the brightness level at a time when the pixel maintains a voltage having the negative polarity. Accordingly, generation of flicker can be suppressed without performing an operation for adjusting the voltage of the opposing electrode. Therefore, there is no electro-optical device that is discarded due to defects in the adjustment process, and energy that is necessary for the adjustment process can be reduced, and whereby an arrangement can be made for the environment.

What is claimed is:

1. A liquid crystal device including a plurality of pixels disposed in correspondence with intersections of a plurality of scanning lines and a plurality of data lines and each having a gray scale according to a voltage of a data signal supplied to the data lines when the scanning line is selected,
wherein, as a voltage corresponding to a gray scale of the pixel positioned on the scanning line, a positive-polarity field in which a voltage having a positive polarity that has an electric potential higher than a predetermined electric potential as a reference is supplied to the data line corresponding to the pixel as the data signal and a negative-polarity field in which a voltage having a negative polarity that has an electric potential lower than the predetermined electric potential as a reference is supplied to the data line corresponding to the pixel as the data signal are included,
the liquid crystal device comprising:
a scanning line selecting circuit that selects the plurality of scanning lines in a predetermined order in each of the positive-polarity field and the negative-polarity field;
a data line driving circuit that, in a case where one scanning line is selected in the positive-polarity field, supplies a voltage corresponding to a gray scale of the pixel positioned on the one scanning line to the data line corresponding to the pixel as the data signal and, in a case where the one scanning line is selected in the negative-polarity field, supplies a voltage corresponding to a gray scale of the pixel positioned on the one scanning line to the data line corresponding to the pixel as the data signal;
a detection circuit that detects brightness of the pixel positioned on the one scanning line; and
a control circuit that controls period lengths of the positive-polarity and negative-polarity fields based on a detection result of the detection circuit such that a difference between brightness of the pixel when the pixel maintains a voltage of the positive polarity and brightness of the pixel when the pixel maintains a voltage of the negative polarity is gradually changed in a predetermined range.

2. The liquid crystal device according to claim 1,
wherein the control circuit includes a first set value that is used for setting the period lengths of the positive-polarity and negative-polarity fields and a second set value that is used for setting the period lengths of the positive-polarity and negative-polarity fields,
wherein the first set value is a value used for setting the period lengths of the positive-polarity and negative-polarity fields such that the brightness of the pixel at a time of maintaining the voltage having the negative polarity is higher than the brightness of the pixel at a time of maintaining the voltage having the positive polarity,
wherein the second set value is a value used for setting the period lengths of the positive-polarity and negative-polarity fields such that the brightness of the pixel at the time of maintaining the voltage having the positive polarity is higher than the brightness of the pixel at the time of maintaining the voltage having the negative polarity, and
wherein the control circuit selects the first set value or the second set value based on the detection result of the detection circuit and controls the period lengths of the positive-polarity and the negative-polarity fields according to the selected set value.

3. The liquid crystal device according to claim 2, wherein the control circuit selects the first set value in a case where the pixel at the time of maintaining the voltage having the positive polarity is brighter than the pixel at the time of maintaining the voltage having the negative polarity and selects the second set value in a case where the pixel at the time of maintaining the voltage having the negative polarity is brighter than the pixel at the time of maintaining the voltage having the positive polarity.

4. The liquid crystal device according to claim 2, wherein one of the first set value and the second set value is a value that is used for setting the period lengths of the positive-polarity and negative-polarity fields to be the same.

5. The liquid crystal device according to claim 2, wherein at least one of the first set value and the second set value is changed to the value that is used for setting the period lengths of the positive-polarity and negative-polarity fields to be the same based on the detection result of the detection circuit.

6. The liquid crystal device according to claim 2, wherein the first set value and the second set value are changed based on the detection result of the detection circuit.

7. The liquid crystal device according to claim 1,
wherein the detection circuit includes an optical sensor that detects brightness of a detection pixel that is determined in advance out of the plurality of pixels, detects the brightness of the pixel at a time when the detection pixel maintains the voltage having the positive polarity and the brightness of the pixel at a time when the detection pixel maintains the voltage having the negative polarity by using the optical sensor, and
wherein the data line driving circuit supplies a voltage corresponding to a halftone gray scale that is determined in advance to the detection pixel.

8. A method of controlling a liquid crystal device including a plurality of pixels disposed in correspondence with intersections of a plurality of scanning lines and a plurality of data lines and each having a gray scale according to a voltage of a data signal supplied to the data lines when the scanning line is selected,
the method comprising:
selecting the plurality of scanning lines in a predetermined order in each of a positive-polarity field and a negative-polarity field;
supplying, in a case where one scanning line is selected in the positive-polarity field, as a voltage corresponding to a gray scale of the pixel positioned on the one scanning line, a voltage having one of a positive polarity that is higher than a predetermined electric potential as a reference or a negative polarity that is lower than the predetermined electric potential as a reference to the data line corresponding to the pixel as the data signal;
supplying, in a case where the one scanning line is selected in the negative-polarity field, as a voltage corresponding to a gray scale of the pixel positioned on the one scanning line, a voltage having the other of the positive polarity and the negative polarity to the data line corresponding to the pixel as the data signal;
detecting brightness of the pixel positioned on the one scanning line at a time when the pixel maintains the voltage having the positive polarity and brightness of the pixel at a time when the pixel maintains the voltage having the negative polarity; and
controlling period lengths of the positive-polarity and negative-polarity fields based on the detection result of brightness of the pixel such that a difference between the brightness of the pixel when the pixel maintains the voltage of the positive polarity and the brightness of the pixel when the pixel maintains the voltage of the negative polarity is gradually changed.

9. A liquid crystal device including a plurality of pixels disposed in correspondence with intersections of a plurality of scanning lines and a plurality of data lines and each having a gray scale according to a voltage of a data signal supplied to the data lines when the scanning line is selected,
wherein, as a voltage corresponding to a gray scale of the pixel positioned on the scanning line, a positive-polarity field in which a voltage having a positive polarity that has an electric potential higher than a predetermined electric potential as a reference is supplied to the data line corresponding to the pixel as the data signal and/or a negative-polarity field in which a voltage having a negative polarity that has an electric potential lower than the predetermined electric potential as a reference is supplied to the data line corresponding to the pixel as the data signal are included,
the liquid crystal device comprising:
a scanning line selecting circuit that selects the plurality of scanning lines in a predetermined order in each of the positive-polarity field and the negative-polarity field;
a data line driving circuit that, in a case where one scanning line is selected in the positive-polarity field, supplies a voltage corresponding to a gray scale of the pixel positioned on the one scanning line to the data line corresponding to the pixel as the data signal and, in a case where the one scanning line is selected in the negative-polarity field, supplies a voltage corresponding to a gray scale of the pixel positioned on the one scanning line to the data line corresponding to the pixel as the data signal;
a detection circuit that detects flicker of the pixel positioned on the one scanning line in the positive-polarity and negative-polarity fields; and
a control circuit that controls period lengths of the positive-polarity and negative-polarity fields based on a detection result of the detection circuit such that the flicker is gradually changed in a predetermined range,
wherein the control circuit includes a first set value that is used for setting the period lengths of the positive-polarity and negative-polarity fields and a second set value that is used for setting the period lengths of the positive-polarity and negative-polarity fields,
wherein the first set value is a value used for setting the period lengths of the positive-polarity and negative-polarity fields such that the brightness of the pixel at a time of maintaining the voltage having the negative polarity is higher than the brightness of the pixel at a time of maintaining the voltage having the positive polarity,
wherein the second set value is a value used for setting the period lengths of the positive-polarity and negative-polarity fields such that the brightness of the pixel at the time of maintaining the voltage having the positive polarity is higher than the brightness of the pixel at the time of maintaining the voltage having the negative polarity, and
wherein the control circuit selects the first set value or the second set value based on the detection result of the detection circuit and controls the period lengths of the positive-polarity and the negative-polarity fields.

10. An electronic apparatus comprising the liquid crystal device according to claim 1.

11. An electronic apparatus comprising the liquid crystal device according to claim 9.
